(19) United States
(12) Patent Application Publication
(10) Pub. No.: US 2009/0037964 A1
(43) Pub. Date: Feb. 5, 2009

(54) SYSTEM FOR ALLOCATING MASS STORAGE FOR VIDEO-ON-DEMAND ASSETS

(75) Inventors: Thomas J. Murray, Longmont, CO (US); David L. McGovern, Superior, CO (US)

Correspondence Address: PATTON BOGGS LLP, 1801 CALFORNIA STREET, SUITE 4900, DENVER, CO, 80202, US

(73) Assignee: YouBiquity, LLC, Superior, CO (US)

(21) Appl. No.: 12/176,136

(22) Filed: Jul. 18, 2008

Related U.S. Application Data
(63) Continuation-in-part of application No. 12/057,881, filed on Mar. 28, 2008.
Application No. 12/057,881 is a continuation-in-part of application No. 12/058,002, filed on Mar. 28, 2008.
Application No. 12/058,002 is a continuation-in-part of application No. 12/058,106, filed on Mar. 28, 2008.
Application No. 12/058,106 is a continuation-in-part of application No. 12/058,332, filed on Mar. 28, 2008.
Application No. 12/058,332 is a continuation-in-part of application No. 12/058,434, filed on Mar. 28, 2008.
(60) Provisional application No. 60/953,527, filed on Aug. 2, 2007.
(60) Provisional application No. 60/953,996, filed on Aug. 4, 2007.
(60) Provisional application No. 60/953,995, filed on Aug. 4, 2007.

(51) Int. Cl. H04N 7/173

(52) U.S. Cl. 725/92

(57) ABSTRACT

The Video-on-Demand Asset Mass Storage System provides the capability to determine the current Asset Multiplicity of each Distinct Asset, including identical Distinct Asset copies, and provides the capability to determine the current Asset Multiplicity of each Alias. The implementation maintains Asset Multiplicity measures as the system operates over time, i.e., as the system and its consumers or the operator create and delete Multi-Media Assets or reorganize Video on Demand Library inventories.

### CROSS-REFERENCE TO RELATED APPLICATIONS

This application is a utility filing which claims priority to U.S. Provisional Application No. 60/953,527, filed Aug. 2, 2007 and titled “Method And System For On-Demand Television Network”; U.S. Provisional Application No. 60/953,995, filed Aug. 4, 2007 and titled “Method And System For Electronic Retail Sales Of Video-on-Demand Assets”; and U.S. Provisional Application No. 60/953,996, filed Aug. 4, 2007 and titled “Method And System For Allocating Mass Storage For Video-on-Demand Assets”. This application also is a Continuation-In-Part of U.S. patent application Ser. No. 12/057,881 filed on Mar. 28, 2008 and titled “Electronic Content Asset Publication System”; U.S. patent application Ser. No. 12/058,002 filed on Mar. 28, 2008 and titled “System For Managing Distributed Assets In An Electronic Content Asset Publication System”; U.S. patent application Ser. No. 12/058,106 filed on Mar. 28, 2008 and titled “System For Distributing Electronic Content Assets Over Communication Media Having Differing Characteristics”; U.S. patent application Ser. No. 12/058,332 filed Mar. 28, 2008 and titled “User Interface Architecture For An Electronic Content Asset Publication System”; and U.S. patent application Ser. No. 12/058,434 filed Mar. 28, 2008 and titled “Personal Content Archive Operable In An Electronic Content Asset Publication System”. This application also is related to the U.S. patent application Ser. No. ______ titled “System For Electronic Retail Sales Of Multi-Media Assets” and filed concurrently herewith. The entire disclosures of each application are incorporated herein by reference.

### FIELD OF THE INVENTION

This invention relates to multi-media communication networks and to a system that is operable in these multi-media communication networks to manage the efficient storage of multi-media assets for customers by representing multiple copies of a single multi-media asset as a collection of logical links which point to a single physical multi-media asset copy.

### BACKGROUND OF THE INVENTION

It is a problem in consumer personal multi-media libraries that multi-media assets, such as movies, documentaries, and television series, are presently saved by consumers on physical media, such as personal DVR storage media or personal network video recorder (NVR) storage media. Thus, there is a tremendous multiplication of copies of multi-media assets stored on consumer physical media. In addition, there are a number of existing multi-media communication networks that serve to provide a consumer with access to selected mass media content sources. These multi-media communication networks include the Public Switched Telephone Network (PSTN), cellular communications systems, the Internet, Cable Television (CATV) systems, satellite communication systems, and the like. These various multi-media communication networks each provide a specific communication medium that is used to deliver multi-media content to the consumer from predetermined multi-media content sources. These multi-media content sources can be a video on demand system that transmits a stream of multi-media files (programs) to customers or can be media repositories (such as a web site or a video on demand system) that deliver multi-media content to the consumer upon receipt of a request from the consumer. However, the consumer does not own the multi-media content and must rely on the multi-media communication network to make the multi-media content available to the consumer.

Therefore, presently there is no system which manages the efficient storage of consumer-owned multi-media assets by representing multiple copies of a single multi-media asset as a collection of logical links which point to a single physical copy of that multi-media asset.

### BRIEF DESCRIPTION OF THE INVENTION

The above-described problems are solved and a technical advance is achieved in the field by the present System For Allocating Mass Storage For Video-on-Demand Assets (termed “Video-on-Demand Asset Mass Storage System” herein) which provides the capability to determine the current Asset Multiplicity of each Distinct Asset, including identical Distinct Asset copies, and which provides the capability to determine the current Asset Multiplicity of each Alias. The implementation maintains Asset Multiplicity measures as the system operates over time, i.e., as the system and its consumers or the operator create and delete Multi-Media Assets or reorganize Video on Demand Library inventories. The Video-on-Demand Asset Mass Storage System may be implemented within any of the systems defined by the above-listed parent patent applications or the above-listed patent application for “System For Electronic Retail Sales Of Multi-Media Assets”, or it may be implemented outside of any such systems using the present definition as a reference description. Without loss of generality, the Video-on-Demand Asset Mass Storage System herein is presented for convenience in the context of the above-listed patent application for “System For Electronic Retail Sales Of Multi-Media Assets.” New terminology defined herein will cross-reference any equivalent terminology defined in the above-listed parent patent applications and the above-listed patent application for “System For Electronic Retail Sales Of Multi-Media Assets”, and such new and equivalent terminology herein will be used interchangeably.

To facilitate management of identical Distinct Asset copies, a Multi-Media Asset Identifier (Asset ID) may be associated to a Distinct Asset. A Multi-Media Asset Identifier unambiguously identifies a Distinct Asset and provides a means to detect or manage identical Distinct Asset copies stored within one or more contemporaneous Video on Demand Libraries. While there are many implementation possibilities, ideally a Multi-Media Asset Identifier is assigned from a universal namespace managed by an authoritative source (e.g., content owner, film studio, standards body, e-retailer, or video on demand operator) to guarantee uniqueness.

### BRIEF DESCRIPTION OF THE DRAWINGS

FIG. 1 illustrates, in block diagram form, the overall architecture of a multi-media communication network which implements a number of communication technologies, and which includes the present Video-on-Demand Asset Mass Storage System;

FIG. 2 illustrates a simplified diagram of the Video-on-Demand Asset Mass Storage System;

FIG. 3 illustrates, in flow diagram form, the operation of the Video-on-Demand Asset Mass Storage System in the publishing of a Multi-Media Asset;

FIG. 4 illustrates, in flow diagram form, the operation of the present Video-on-Demand Asset Mass Storage System;

FIGS. 5A and 5B illustrate, in block diagram form, typical centralized and distributed Publisher/Subscriber database architectures where the database is shared among multiple operators;

FIG. 6 depicts the nomenclature and symbols used for FIGS. 7-15;

FIG. 7 depicts an Operator Library with N Distinct Assets;

FIG. 8 shows a Consumer Library holding N Distinct Assets for one Consumer;

FIG. 9 portrays a Consumer Library holding two Distinct Assets for each of two Consumers;

FIG. 10 illustrates a Video on Demand Library holding ten operator Distinct Assets, two Distinct Assets for a first Consumer, one Distinct Asset for a second Consumer, and three Distinct Assets for a third Consumer;

FIG. 11 depicts a Spanned Library comprising a Consumer Library and an Operator Library. The Consumer Library holds one Distinct Asset and an Alias for a Distinct Asset held in the Operator Library;

FIGS. 12a-12f show six different representations of two Consumers holding a Multi-Media Asset with an Asset ID of “1”. FIGS. 12a, 12c, and 12d each depict two occurrences of the same Distinct Asset as might be the case before de-duplication is performed, whereas FIG. 12f represents one Multi-Media Asset as an identical Distinct Asset copy of the other Multi-Media Asset, as might be the case after de-duplication has been performed;

FIG. 13 illustrates 24 Aliases, each of which belongs to a different Consumer, and each Alias is stored in a Consumer Library belonging to its owner; and

FIGS. 14 and 15 illustrate how the present Video-on-Demand Asset Mass Storage System may dynamically improve the representation of FIG. 13.

### DETAILED DESCRIPTION OF THE INVENTION

Multi-Media Asset. A Multi-Media Asset is any machine readable, pre-recorded digital multi-media content such as a movie, television series episode, sports event, music, text, graphics, etc. A Content Owner holds the Multi-Media Asset copyright. A Retail Operator may electronically sell, lease, or register a Multi-Media Asset to a Consumer on behalf of a Content Owner. A Storage Operator may store a Multi-Media Asset in a Network-Based Consumer Multi-Media Library on behalf of a Consumer. A Multi-Media on Demand Operator may retransmit a Multi-Media Asset, held by a Storage Operator in a Network-Based Consumer Multi-Media Library, on behalf of a Consumer. A Consumer may view a Multi-Media Asset on demand as authorized by a Content Owner or by another Consumer. In the above-listed parent patent applications, a Multi-Media Asset is equivalent to an Electronic Content Asset, Subscriber Asset, Operator Asset, Distinct Asset, or Local Asset.

Consumer. A Consumer electronically purchases or leases a Multi-Media Asset from a Retail Operator or electronically registers a physical Multi-Media Asset via a Retail Operator, and may view these Multi-Media Assets on demand via cable television, satellite television, IPTV, the Internet, or on any web-enabled devices including personal computers, cell phones, PDAs, etc. A Content Owner may authorize a Consumer to purchase, lease, register, possess, store, transmit, retransmit, share, and view a Multi-Media Asset per the terms of sale. In the above-listed parent patent applications, a Consumer is equivalent to a subscriber or a Subscriber.

Network-Based Consumer Multi-Media Library. A Consumer may own or lease one or more Network-Based Consumer Multi-Media Libraries to store electronically purchased, leased, or registered Multi-Media Assets acquired by or accessible to the Consumer. The collection of Network-Based Consumer Multi-Media Libraries held by a Consumer may be stored by a single Storage Operator or by multiple Storage Operators. A Network-Based Consumer Multi-Media Library is also called a Consumer Library. In the above-listed parent patent applications, a Network-Based Consumer Multi-Media Library is equivalent to a Personal Video Archive, a Subscriber Library, or a Video on Demand Library.

Multi-Media Asset Storage. Multi-Media Asset Storage is any suitable long-term digital storage media for Multi-Media Assets and Network-Based Consumer Multi-Media Libraries. A Multi-Media Asset Storage facility may utilize a hierarchical storage system comprising a collection of different types of storage media and control software that implements the storage hierarchy.

Storage Operator. A Storage Operator provides digital Multi-Media Asset Storage facilities to Consumers for Network-Based Consumer Multi-Media Libraries. A Content Owner may authorize a Storage Operator to store Multi-Media Assets electronically purchased, leased, or registered by Consumers. A Storage Operator electronically receives a Multi-Media Asset or a Multi-Media Asset Entitlement from a Retail Operator and deposits it in a Network-Based Consumer Multi-Media Library designated by the Consumer. A Storage Operator may provide access to the Network-Based Consumer Multi-Media Library to Content Owners, Retail Operators, Multi-Media on Demand Operators, Consumers, or other Storage Operators. A Storage Operator may be a commercial data center operator, an Internet Service Provider (ISP), an online storage provider, a television head-end or super head-end operator, etc. In the above-listed parent patent applications, a Storage Operator may be a Video Content Host Site operator or an All Video On-Demand Network operator.

Multi-Media on Demand Operator. A Multi-Media on Demand (MMoD) Operator utilizes its multi-media on demand distribution facilities to deliver a Multi-Media Asset from a Network-Based Consumer Multi-Media Library to the Consumer that purchased, leased or registered it, or to a Consumer who has acquired access privileges for that Multi-Media Asset. A Content Owner may authorize a Multi-Media on Demand Operator to retransmit Multi-Media Assets stored in Network-Based Consumer Multi-Media Libraries to Consumers on demand. Multi-Media on Demand Operators include cable, satellite, IPTV, and Internet-based operators. In the above-listed parent patent applications, a Multi-Media on Demand Operator is equivalent to an operator or a video on demand operator and may be a Video Content Host Site operator or an All Video On-Demand Network operator.

### Multi-Media Communication Network Examples

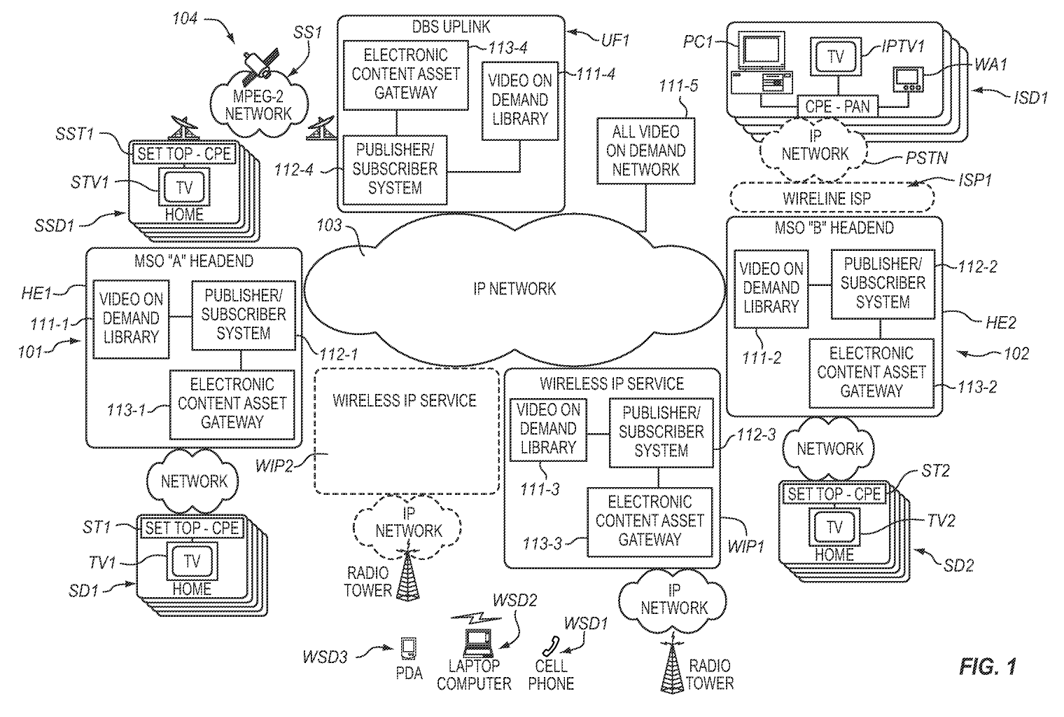

FIG. 1 illustrates, in block diagram form, the overall architecture of a multi-media communication network which implements a number of communication technologies, and which includes various elements of the present Video-on-Demand Asset Mass Storage System. This view of multi-media communication networks is at a conceptual level, where the specific implementation details are omitted for the sake of clarity. A typical multi-media communication network comprises a plurality of physical elements to implement the communication mediums and associated signal distribution control systems. These functions are simply illustrated as the “Network” that interconnects and serves Consumer devices and Multi-Media Asset sources. Note that today these networks are not interoperable for multi-media content distribution among all network nodes.

Examples of such multi-media communication networks include a Cable Television Network 101 and 102 that interconnects a plurality of Consumer devices SD1 and SD2, each comprising a television set TV1 and TV2 and its associated “set-top box” ST1 and ST2, with the program source comprising a Master System Operator head-end HE1 and HE2 that receives program content from various sources and delivers the program content to Consumers via a plurality of concurrently broadcast channels. The Master System Operator head-end HE1 and HE2 is also shown as interconnected with the Internet 103. A Satellite Television Network 104 interconnects a plurality of Consumer devices SSD1, each comprising a television set SSTV1 and its associated “set-top box” SST1, with the program source comprising a Master System Operator uplink facility UF1 that receives program content from various sources and delivers the program content to Consumers via a satellite system SS1 that transmits a plurality of concurrently broadcast channels. The Master System Operator uplink facility UF1 is also shown as interconnected with the Internet 103. Another multi-media communication network comprises a wire-line Internet Service Provider ISP1 that interconnects Consumer devices ISD1, such as personal computers PCI, IP Televisions IPTV1, and other appliances WA1, with a program source via the Public Switched Telephone Network PSTN. The Internet Service Provider ISP1 may provide program content or simply interconnect the Consumer device with an entity, also served by the Internet 103, which contains the program content. A variation of the wire-line Internet Service Provider ISP1 is a wireless IP Service WIP1 and WIP2 that interconnects portable Consumer devices WSD1-WSD3, such as cellular telephones WSD1, personal computers WSD2 PDAs, and WSD3 and the like, with a program source via the Cellular Telephone Network. The wireless IP Service Provider WISP1 and WISP2 may provide program content or simply interconnect the Consumer device with an entity, also served by the Internet 103, which contains the program content.

Connected to the multi-media communication networks, either directly or via the Internet 103, are a plurality of elements (typically distributed) that operate to implement the present Video-on-Demand Asset Mass Storage System in a multi-media communication network. These elements include a Publisher/Subscriber System component 112-1 to 112-4 that functions to register published Multi-Media Assets. In addition, Publisher/Subscriber System component 112-1 to 112-4 uses the Consumer (subscriber) unambiguous identity credentials and the Multi-Media Asset Identifier to determine whether a Consumer is authorized to access a Multi-Media Asset, and to initiate delivery of that Multi-Media Asset to the Consumer via a multi-media communication medium. The Publisher/Subscriber System component 112-1 to 112-4 may also include an entity that promotes a standardized method for rating content and establishing its appropriateness for particular classes of Consumers, and for authorizing or denying Multi-Media Asset access based on those ratings or classifications and the Consumer's class membership. Certain Multi-Media Assets are stored in various locations in this multi-media communication network and these are noted as Video on Demand Libraries 111-1 to 111-4, which are located in the various multi-media communication networks noted above. Certain other Multi-Media Assets such as live feeds or live streams are distributed within this multi-media communication network and might not be stored anywhere in this multi media communication network. In addition, All Video On-Demand Network 111-5 is shown as connected to the Internet and functions to provide multi-media on demand content and personalized Consumer services to the various multi-media communication networks noted above. Finally, Electronic Content Asset Gateway component 113-1 to 113-4 is shown and includes various multi-media communication network intercommunication and media translation functions as described below. These elements collectively operate with the existing multi-media communication networks and comprise the present Video-on-Demand Asset Mass Storage System.

The Video-on-Demand Asset Mass Storage System acquires, stores, publishes, distributes, accesses, and processes Multi-Media Assets on demand and over a multi-media communications infrastructure. The Video-on-Demand Asset Mass Storage System, for example, enables Consumers to digitally record multi-media content and to access live and recorded multi-media content for viewing on a conventional television set or a suitable Web-Enabled Device (WED), e.g., a personal computer, a PDA or a cell phone.

The Video-on-Demand Asset Mass Storage System also provides the capability for the Consumer to permit others to access their personal live and recorded Multi-Media Assets on a television set or a WED device. Consumers may access Multi-Media Assets for viewing at the same physical location where the Multi-Media Assets originate, or for viewing from a remote location, perhaps one situated at a great distance from the origin site.

### Publisher/Subscriber (P/S) Model

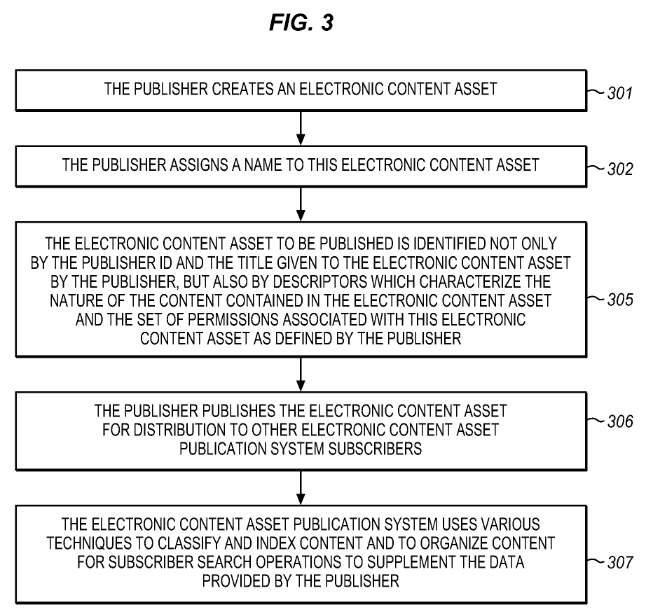

FIG. 3 illustrates, in flow diagram form, the operation of the Video-on-Demand Asset Mass Storage System in the publishing of a Multi-Media Asset. In order to understand the ubiquity and diversity of the Multi-Media Assets and their management, a Publisher/Subscriber (P/S) model is used to define the Content On-Demand content ubiquity aspect of the Video-on-Demand Asset Mass Storage System. The Publisher/Subscriber model logically provides a virtual multi-media canvas upon which a subscriber (Consumer), who is called a Publisher, may prepare or compose a Multi-Media Asset for publication. Such Multi-Media Asset preparation or composition processes may specify a layout format which may be a tiled format, picture-in-picture format, or any other format, and which may indicate the layout format in which the Multi-Media Asset should be rendered for viewing on a subscriber multi-media device. The example used herein to illustrate this concept is the creation of a Multi-Media Asset from one or more live or recorded camera feeds (each feed is one or several camera feeds combined as one feed) and/or Multi-Media Asset Metadata sources as defined below. The Publisher creates this Multi-Media Asset at step 301, assigns a name to this Multi-Media Asset at step 302, and publishes the Multi-Media Asset for distribution to other Video-on-Demand Asset Mass Storage System subscribers at step 306, who are called Authorized Subscribers. The Publisher/Subscriber system at step 305 may assign descriptors that indicate a content rating for the published Multi-Media Asset or the appropriateness for access by particular classes of subscribers. The Publisher/Subscriber system subsequently may authorize or deny Multi-Media Asset access based on these ratings or classifications and the subscriber's class membership. An Authorized Subscriber may access a Multi-Media Asset on demand, in accordance with the terms of publication associated with this Multi-Media Asset. The Video-on-Demand Asset Mass Storage System logically publishes each such created Multi-Media Asset to the Multi-Media Asset's own Publisher with no restrictions on its use; hence, the Publisher/Subscriber model logically applies uniformly to all Multi-Media Assets within the present Video-on-Demand Asset Mass Storage System. The Publisher of a Multi-Media Asset may update any characteristics of the published Multi-Media Asset at any time.

A Publisher may use Video-on-Demand Asset Mass Storage System interactive design tools or layout tools to specify the composition, layout, or format of one or more Multi-Media Assets comprising a new Multi-Media Asset, including the placement or location of individual Multi-Media Assets upon the virtual layout canvas; or to specify the Multi-Media Assets to be used as backgrounds, wallpapers, borders, window frames, colors, fonts, graphics, icons; or to specify any other layout or design elements or resources, etc. A Multi-Media Asset composition or layout may also specify interactive features, renderings, animations, etc. For example, a Publisher may compose a Multi-Media Asset that is a collection of other Multi-Media Assets that are digital image files; next, the Publisher may lay out this composed Multi-Media Asset in a window placed at a particular location on the virtual canvas and may specify the Multi-Media Asset shall be rendered or animated for viewing as a cyclic linear progression of its individual underlying Multi-Media Asset digital image files. Multi-Media Asset composition and layout data or metadata specified by the Publisher is stored in Publisher/Subscriber database entries describing the published Multi-Media Asset. Multi-Media Asset composition data or metadata may include the name or address of each multi-media stream or file comprising a published Multi-Media Asset. For example, Multi-Media Asset composition data or metadata may indicate the multi-media network address of a live stream, or the name and multi-media network address of a Video on Demand Library, along with the name of a multi-media file stored in that Video on Demand Library.

The Publisher/Subscriber model defines a secure one-to-many subscription relationship that limits access to each Multi-Media Asset to a specified Authorized Subscriber base. Further, the publication process establishes a set of publication terms-of-use that may include, but are not limited to, republication rights, scheduled availability, medium access rights, device access rights, and so on. Re-publication terms-of-use establish whether or not an Authorized Subscriber has the right to re-publish a Multi-Media Asset to other Authorized Subscribers, with optional limits on the breadth and depth of the re-publication privilege for the Multi-Media Asset. Schedule terms-of-use allow the Publisher to specify when a Multi-Media Asset may be accessed, including, but not limited to, start date/time and duration, expiration date/time, recurrence frequency, and so on. Medium access rights terms-of-use define the multi-media communication medium(s) from which a published Multi-Media Asset may be accessed, e.g., the public Internet, cable television network, wireless network, and any other multi-media communication mediums. Device access rights terms-of-use define the multi-media device(s) from which a published Multi-Media Asset may be viewed, e.g., cell phones, PDAs, Personal Computers, cable TVs, satellite TVs, IPTV, and any other multi-media devices. A Publisher may selectively revoke subscription rights to a selected Multi-Media Asset at any time. The revocation of subscription rights may recursively expunge all republished instances of the selected Multi-Media Asset. An Authorized Subscriber may unsubscribe from a Multi-Media Asset at any time.

Re-publication relationships may be private, semi-private, or public. A private republication relation limits Multi-Media Asset access to the Authorized Subscribers who are assigned subscription rights firsthand by the Publisher, i.e., all re-publication rights to the Multi-Media Asset are disallowed. A semi-private re-publication relation limits re-publication capabilities, for example, by allowing each firsthand Authorized Subscriber to optionally re-publish the Multi-Media Asset to only one other Authorized Subscriber. A public re-publication relation grants access to the Multi-Media Asset to every subscriber. All publication terms-of-use may apply to all three re-publication relations including schedule terms-of-use, medium access rights terms-of-use, and device access rights terms-of-use.

### Subscriber Unambiguous Identity Credentials

Every subscriber (Consumer), including every Publisher and every Authorized Subscriber, must have an unambiguous identity within the present Video-on-Demand Asset Mass Storage System. The present Video-on-Demand Asset Mass Storage System may use an identity-agnostic scheme for authenticating subscriber unambiguous identity credentials, for example, a scheme where subscriber unambiguous identity credentials are issued and authenticated by one or more Video Content Host Site operators or by other entities operating beyond the present Video-on-Demand Asset Mass Storage System; other forms of subscriber unambiguous identity credentials are possible. An illustrative example used herein of a subscriber unambiguous identity credential is a fully-qualified E-mail address of the form “username domainname” together with the password for that E-mail account, both of which are registered with one of the Video Content Host Site operators within the present Video-on-Demand Asset Mass Storage System. If a subscriber has unambiguous identity credentials registered with more than one Video Content Host Site operator in a Video-on-Demand Asset Mass Storage System or registered with more than one other entity operating beyond the present Video-on-Demand Asset Mass Storage System, the subscriber is said to have unambiguous identity aliases, and each such alias unambiguously identifies the subscriber within the present Video-on-Demand Asset Mass Storage System. A Publisher publishes a Multi-Media Asset by specifying the unambiguous identities and any unambiguous identity aliases of one or more Authorized Subscribers who may access that Multi-Media Asset. In the illustrative example used herein, the Publisher specifies one or more fully-qualified E-mail addresses for each Authorized Subscriber permitted to access a published Multi-Media Asset. The unambiguous identities and unambiguous identity aliases specified by a Publisher are stored in Publisher/Subscriber database Authorized Subscriber entries describing the published Multi-Media Asset and are known collectively as the Authorized Subscriber List for that Multi-Media Asset.

An Authorized Subscriber must present an unambiguous identity or an unambiguous identity alias as identity credentials for accessing a Multi-Media Asset. For Multi-Media Asset access from a WED device, an Authorized Subscriber uses GUI-WED or GUI-WEB to sign on from a WED device and then declare an unambiguous identity or any unambiguous identity aliases to be used for accessing Multi-Media Assets during that sign-on session. Video Content Host Site identity credential authentication software should authenticate these identity credentials before the Authorized Subscriber may use these identity credentials to access any Multi-Media Assets. Video Content Host Site identity credential authentication software may, for example, require an Authorized Subscriber to enter the password for each fully-qualified E-mail address listed as an unambiguous identity or unambiguous identity alias; and Video Content Host Site identity credential authentication software may contact the “domainname” site specified as a part of each E-mail address to verify that the given password for “username domainname” is a valid password. Other forms of Authorized Subscriber identity credential authentication are possible.

For Multi-Media Asset access from a cable television set, an Authorized Subscriber presents unambiguous identity or unambiguous identity alias credentials to the cable operator which is functioning as a Video Content Host Site operator. The cable operator may establish a default Authorized Subscriber unambiguous identity by matching the serial number or other unique data obtained from the Authorized Subscriber's set-top box or equivalent cable receiver device with the Authorized Subscriber's cable account information held on file. An Authorized Subscriber may supply any unambiguous identity or unambiguous identity aliases via an interactive program guide menu or screen, which may be a GUI-IPG menu or screen. An Authorized Subscriber may also “sign off” of the Video-on-Demand Asset Mass Storage System from a cable television set so that another Authorized Subscriber may sign on from the same cable television set to supply his or her own unambiguous identity credentials. Video-on-Demand Asset Mass Storage System identity credential authentication software hosted by the cable operator which is functioning as a Video Content Host Site operator should authenticate all Authorized Subscriber identity credentials before the Authorized Subscriber may use those identity credentials to access any Multi-Media Assets. The cable operator's identity credential authentication method may be the same method described herein to authenticate Authorized Subscriber identity credentials for Multi-Media Asset access from a WED device. An Authorized Subscriber may similarly sign on to the Video-on-Demand Asset Mass Storage System from an IPTV television set or a satellite television set and may then supply their unambiguous identity credentials.

Video Content Host Site applications may use authenticated Authorized Subscriber identity credentials to retrieve a list of Multi-Media Assets published to the Authorized Subscriber by querying one or more Publisher/Subscriber databases for all Multi-Media Assets published to each authenticated unambiguous identity or each authenticated unambiguous identity alias specified by this Authorized Subscriber. An Authorized Subscriber may access any Multi-Media Asset that is published to any of his or her authenticated unambiguous identity credentials, subject to any publication terms-of-use conditions specified by the Publisher or imposed by the present Video-on-Demand Asset Mass Storage System.

### Video Content Host Site (VCHS)

A Video Content Host Site (VCHS) is any data center that hosts the Video-on-Demand Asset Mass Storage System elements located at that particular site. Such a data center may also host other applications not related to the present Video-on-Demand Asset Mass Storage System. A single Video Content Host Site implementation may span all or part of a networked data center. If the Video Content Host Site facility spans multiple physical locations, the individual sites may or may not be co-located within the same geographic locale. The Video Content Host Site managing entity is called a Video Content Host Site operator. A cable, satellite, or IPTV operator, or an Internet service provider, or an online multi-media mass storage provider may be a Video Content Host Site operator. A cable, satellite, or IPTV head-end or super head-end system, or an Internet service provider, or an online multi-media mass storage provider may function as a Video Content Host Site. A particular Video Content Host Site operator may own or operate multiple Video Content Host Sites.

Video Content Host Site network traffic may traverse the Video Content Host Site logical or physical Network Access Layer (NAL), which is a portal for Video Content Host Site multi-media communication network access. Network Access Layer services include public, semi-private, and private network access. Public access includes public Internet access. Semi-private access includes inter-operator access, possibly via the Electronic Content Asset Gateway as described below. Private access may be limited to intra-operator access. The Network Access Layer may implement Electronic Content Asset Gateway data interchange facilities, e.g., protocol converters, transcoders, encoders and decoders, modulators and demodulators, multiplexers and demultiplexers, etc. Video-on-Demand Asset Mass Storage System subscriber (Consumer) accounts may be hosted at a Video Content Host Site and may be stored in a computer database system. Subscriber account information may include, but is not limited to, the typical communications account data: subscriber name, billing address, phone number, E-mail address, and account payment information; Video-on-Demand Asset Mass Storage System subscriber login name and password; list of Video-on-Demand Asset Mass Storage System services to which the subscriber is authorized; subscriber's home Video Content Host Site; network location of the subscriber's Digital Video Content Recorders, Network Video Content Recorders, or streaming media servers or applications; metadata describing the subscriber's personal Multi-Media Assets stored at this Video Content Host Site; Multi-Media Asset storage and security policies; mass storage quota; configuration change history; security certificates; video processing results such as reports, charts, graphs, spreadsheets and data files; and so on.

Video Content Host Site mass storage or Digital Video Content Recorder mass storage may be allocated to one or more Video on Demand Libraries. This mass storage is accessible by Video Content Host Site or Digital Video Content Recorder video on demand transmission and streaming applications, application server computers, application software programs, and multi-media communication network infrastructure. This mass storage may be located at the Video Content Host Site head-end, super head-end, or multi-media content server facility or within a Digital Video Content Recorder, and may be any suitable multi-media file storage media.

A Video on Demand Library may store Subscriber Assets, which are Multi-Media Asset files owned by subscribers. A Personal Video Archive thus comprises mass storage allocations and Multi-Media Asset multi-media files in one or more Video on Demand Libraries. A Personal Video Archive is called a Video on Demand Library, but this designation is merely shorthand for the underlying Personal Video Archive implementation. A Video on Demand Library may store Operator Assets, which are Multi-Media Asset multi-media files owned by Video Content Host Site operators. Operator Assets also may be stored in a Video on Demand Library residing on a Digital Video Content Recorder that is owned by an operator and located at a subscriber premises. A Video on Demand Library that exclusively stores Subscriber Assets is called a Subscriber Library. A Video on Demand Library that exclusively stores Operator Assets is called an Operator Library. A Video on Demand Library may contemporaneously store both Subscriber Assets and Operator Assets.

Conceptually, a Video on Demand Library is any data structure, abstract data type, or object model comprising a Multi-Media Asset Catalog and a Multi-Media Asset Storage Facility. One or more Video on Demand Library instances may exist contemporaneously on Video Content Host Site mass storage or on Digital Video Content Recorder mass storage. Each Video on Demand Library instance may be accessible by name and may exist, for example, as or within one or more databases, file systems, or custom software applications. Each Video on Demand Library Multi-Media Asset multi-media file is accessible, by name or otherwise, to the Video Content Host Site software applications or Digital Video Content Recorder software applications that must process it, such as video on demand transmission or streaming applications.

Multi-Media Asset multi-media files and Multi-Media Asset Metadata multi-media files stored in Video on Demand Libraries are called Distinct Assets. Identical copies of a Distinct Asset may exist contemporaneously within one or more Video on Demand Libraries. The Video-on-Demand Asset Mass Storage System tracks ownership by a particular subscriber or operator for each Distinct Asset and may support ownership-related queries for Distinct Assets. Multi-Media Assets, Multi-Media Asset Metadata, and Distinct Assets are also called Video on Demand Assets. A Video on Demand Library configuration may consist of a single Video on Demand Library instance containing Subscriber Assets and Operator Assets. A Video on Demand Library configuration called a Spanned Library consists of a Subscriber Library for each subscriber and one or more Operator Libraries. Other Video on Demand Library configurations are possible.

The Multi-Media Asset Catalog indexes the Multi-Media Asset multi-media file collection comprising a Video on Demand Library configuration. This multi-media file collection is stored in the Multi-Media Asset Storage Facility of this Video on Demand Library configuration. A Multi-Media Asset Catalog Entry stores a set of attributes for a Multi-Media Asset multi-media file as metadata that may include, but is not limited to, the Multi-Media Asset name, Multi-Media Asset multi-media file name, Multi-Media Asset type, Multi-Media Asset Identifier, Multi-Media Asset Multiplicity, Multi-Media Asset creation date, Multi-Media Asset Logical Delete Indicator, Multi-Media Asset last reference date, Multi-Media Asset Owner, Multi-Media Asset access permissions, and the Multi-Media Asset File Location.

The ingest, upload, recording, copy, import, file transfer, archive, backup/restore, purchasing, and leasing functions of Network Video Content Recorders, streaming media applications, Digital Content Video Recorders, and Video Content Host Site application software programs, any of which may be provided by operators and which may be accessible by subscribers, create, write, update, or store Multi-Media Asset multi-media files and Multi-Media Asset Metadata multi-media files in Subscriber Libraries or Operator Libraries. Any function that creates or stores Multi-Media Assets or Multi-Media Asset Metadata may implement an Asset Duplication Strategy. The Asset Duplication Strategy determines the number of identical copies of a Multi-Media Asset to be created or stored. Any function that stores Multi-Media Assets or Multi-Media Asset Metadata may implement an Asset Placement Strategy to select a Video on Demand Library instance for the new Distinct Asset. The Asset Placement Strategy selects a Video on Demand Library instance to store the Multi-Media Asset Catalog Entry and selects a Video on Demand Library instance to store the associated Distinct Asset multi-media file; the Asset Placement Strategy may select the same library in both cases, or it may select two different libraries. Further, for a Spanned Library configuration, the selected library instances may be Subscriber Libraries, Operator Libraries, or one of each depending on requirements. The search/playback and video on demand functions of Network Video Content Recorders, streaming media applications, Digital Content Video Recorders, and Video Content Host Site application software programs, which may be accessible by subscribers, read or retrieve Multi-Media Asset multi-media files and Multi-Media Asset Metadata multi-media files stored in Subscriber Libraries or Operator Libraries. Video-on-Demand Asset Mass Storage System video processing applications may analyze a subscriber's Personal Video Archive content and store the results in the subscriber's Personal Video Archive. Personal Video Archive content is organized or indexed by attributes such as Multi-Media Asset name, creation date and time, source (e.g., Digital Video Content Recorder, Network Video Content Recorder), camera identity, etc., and is indexed for random-access retrieval or video on demand retrieval by these attributes.

For each Video-on-Demand Asset Mass Storage System subscriber account hosted at a particular Video Content Host Site, the Video Content Host Site operator may store the associated Personal Video Archive entirely at that site. If the Video Content Host Site operator owns or operates multiple Video Content Host Sites, the operator may disperse its Personal Video Archive mass storage over several Video Content Host Sites and store part of a subscriber's Personal Video Archive at one Video Content Host Site and the remainder at one or more other Video Content Host Sites. Similarly, the Video-on-Demand Asset Mass Storage System Consumer account database mass storage may be centralized or distributed as the Video Content Host Site operator sees fit.

A Video Content Host Site operator may implement mass storage policies, typically including a quota system which indicates the maximum amount of Video Content Host Site Personal Video Archive mass storage a subscriber may allocate. The subscriber's current Personal Video Archive allocation may not exceed the quota. Personal Video Archive storage policies are rules that govern mass storage usage including, but not limited to, the length of time to retain a subscriber's stored Multi-Media Asset multi-media files; what to do when a subscriber's Personal Video Archive storage allocation reaches the quota; and so on. Storage policy examples include, but are not limited to, deleting the oldest stored Multi-Media Asset multi-media files to make room for new Multi-Media Asset multi-media files; automatically procuring additional Personal Video Archive capacity when the quota is reached, thereby dynamically establishing a new quota (“storage on demand”); and so on.

The Video Content Host Site Consumer access typically is web-based or network-based. A Video Content Host Site runs one or more web servers as portals to host subscriber logins and to serve GUI-WEB web pages. Subscribers and software applications may also access Video Content Host Site functions over the network via Video-on-Demand Asset Mass Storage System GUIs and APIs. Video Content Host Site server computers host subscriber login sessions and Multi-Media Asset Publication System software applications launched by subscribers or operators, including but not limited to, one or more Network Video Content Recorders, streaming media applications, ingest applications, upload services, archive/retrieval operations, video processing applications, and so on. Other Video Content Host Site server software provides support for Video-on-Demand Asset Mass Storage System GUI and API functions including, but not limited to, account management, streaming media applications, Multi-Media Asset creation, composition and publication, Electronic Content Asset Gateway, Personal Video Archive management, security policy administration and enforcement, and so on. Subscribers and operators use Network Video Content Recorders and streaming media applications to stream, or to record as subscriber Distinct Assets or operator Distinct Assets, the following content sources: network camera feeds, television programming, Digital Video Content Recorder network streams, or any other content sources.

The essence of the Video Content Host Site is a centralized Multi-Media Asset repository; a centralized subscriber web portal; a centralized subscriber database and account administration function; a centralized control point for Multi-Media Asset and Multi-Media Asset Metadata creation, storage, processing, and distribution; a platform for Video-on-Demand Asset Mass Storage System software applications; a central control point for the Publisher/Subscriber Model; an Electronic Content Asset Gateway platform; a central control point for Network Video Content Recorders and streaming media servers and applications; a central control point for recording network camera streams, television programming and other content sources; and other functions explained herein. Further, as an IT datacenter, a Video Content Host Site has myriad physical and logical realizations.

The Video-on-Demand Asset Mass Storage System uses various techniques at step 307 and elsewhere during operation to classify and index content and to organize Multi-Media Assets for subscriber search operations to supplement the Multi-Media Asset data or metadata provided by the Publisher. Subject classification and indexing is an important value-added service that helps subscribers efficiently and effectively navigate an enormous array of content by maximizing the likelihood that the search results are compact and contain the desired item(s). Unlike textual content, which is trivially amenable to algorithmic classification methods, video content typically must be interpreted and classified manually or with specialized video analytics applications. The classification process involves reviewing content for various attributes or characteristics of interest, noting those that apply, and loading classification databases with the resulting descriptive metadata. Subscribers may browse Multi-Media Asset collections by any of the stock classification categories provided by the Video-on-Demand Asset Mass Storage System, or they may search the classification databases directly by posing ad hoc queries. Searches may return available titles and Multi-Media Asset Catalog Entry information such as the location of a Multi-Media Asset, which may reside inside (Multi-Media Asset Internal Location) or outside (Multi-Media Asset External Location) of the present Video-on-Demand Asset Mass Storage System.

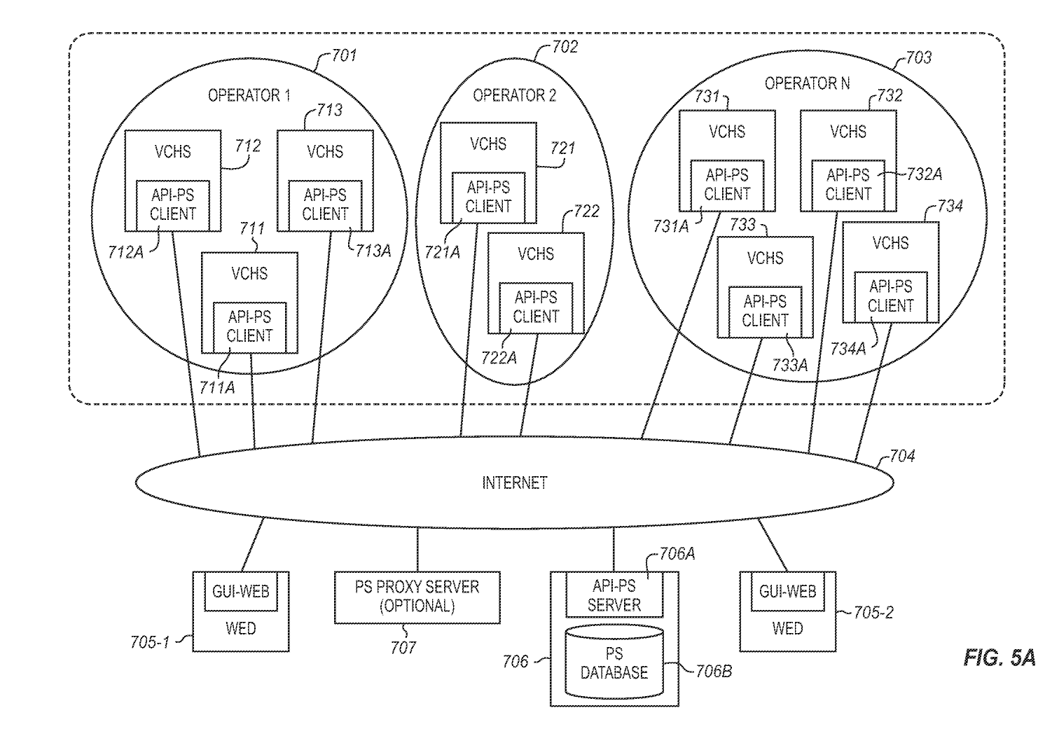

FIG. 5A illustrates, in block diagram form, a centralized Publisher/Subscriber database architecture where the database is shared among multiple operators. This figure illustrates three operators 701-703, each of which includes a plurality of Video Content Host Sites (711-713, 721-722, and 731-734, respectively) for the storage of Multi-Media Assets. FIG. 5B illustrates, in block diagram form, a distributed Publisher/Subscriber database architecture where the Publisher/Subscriber databases 716B, 726B, and 736B are shared via associated API-PS Servers 716A, 726A, and 736A among multiple operators. This figure illustrates three operators 701-703, each of which includes a plurality of Video Content Host Sites (711-713, 721, and 731-732, respectively) for the storage of Multi-Media Assets. A distributed Publisher/Subscriber database consists of the logical union of centralized Publisher/Subscriber databases belonging to all of the affiliated operators. Multiple Publisher/Subscriber databases 716B, 726B, and 736B may be for different purposes, e.g., one database for all subscriber video content and another for a multi-operator aggregate Video on Demand Library.

### Electronic Retail Value Chain Elements

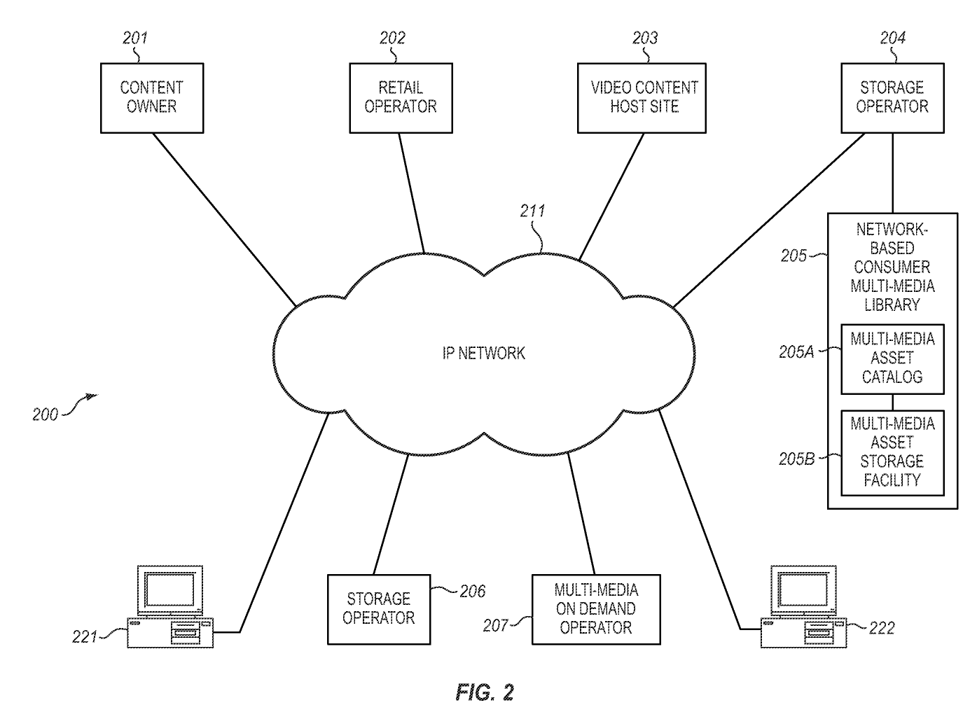

FIG. 2 illustrates a simplified diagram of the present Video-on-Demand Asset Mass Storage System 200. This section describes the electronic retail value chain elements and high level process flows of the Video-on-Demand Asset Mass Storage System 200. Separate entities, e.g., separate companies, may perform each of the following roles, or a single entity may perform two or more of these roles: Content Owner 201, Retail Operator 202, Storage Operator 204, Multi-Media on Demand Operator 207. These entities may also conduct other business unrelated to the Video-on-Demand Asset Mass Storage System 200.

The APIs defined for the present Video-on-Demand Asset Mass Storage System 200 clarify various API client-side and server-side roles and responsibilities and are especially convenient descriptions when one entity provides the API client support and another entity, e.g., a separate or autonomous business partner, provides the API server support. Any API described in this disclosure may be obviated, reduced, or replaced through substitution when the same entity logically performs both the client-side and server-side API roles. For example, a cable operator may act as a Retail Operator 201 to electronically sell, lease, or register a collection of Multi-Media Assets that it holds in its own storage facility. This cable operator may also act as a Storage Operator 204 to provide Network-Based Consumer Multi-Media Libraries 205 for its Consumers. This cable operator may use its own methods to deposit a Multi-Media Asset, which was electronically purchased, leased, or registered by one of its Consumers, in a Network-Based Consumer Multi-Media Library 205 that is assigned to that Consumer 221 and resides in the cable operator's mass storage facility. This cable operator may also use its own methods to stream this Multi-Media Asset to the Consumer 221 on demand.

Any such electronic retail methods and process flows, any of which may be proprietary, are clearly recognized by those of ordinary skill in the art as logical equivalents of the methods and process flows of the present Video-on-Demand Asset Mass Storage System 200, including methods defined by the APIs of the present Video-on-Demand Asset Mass Storage System 200. Similarly, any user interface defined by the present Video-on-Demand Asset Mass Storage System 200 may be replaced through substitution or may be incorporated by the provider's native user interface system; but such user interfaces are clearly recognized by those of ordinary skill in the art as logical equivalents of the user interfaces of the present Video-on-Demand Asset Mass Storage System 200.

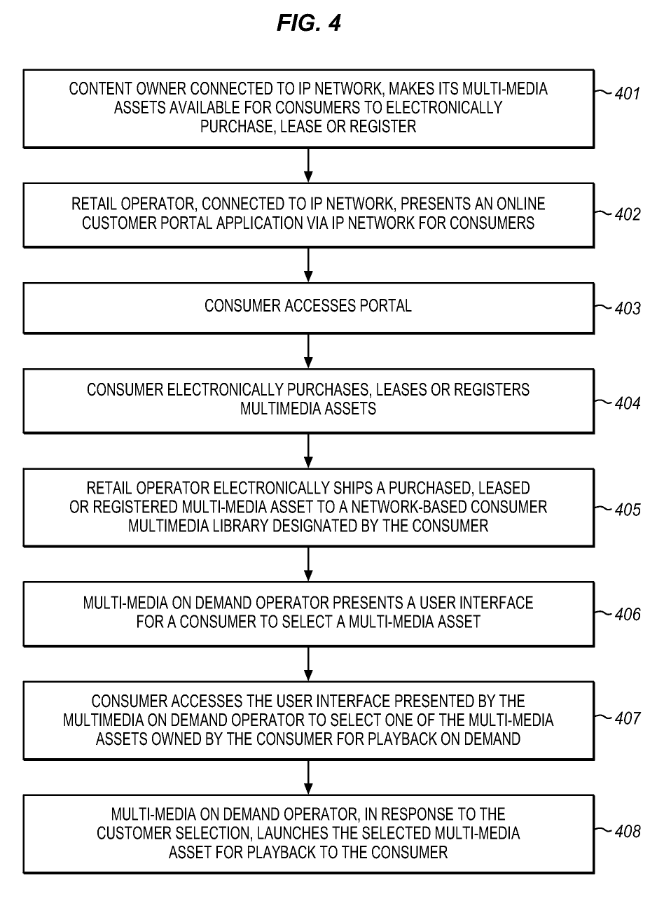

FIG. 4 illustrates, in flow diagram form, the operation of the present Video-on-Demand Asset Mass Storage System 200. An outline of the basic process flow of the entire system is as follows. A Content Owner 201, connected to the communication medium noted as IP Network 211, makes its Multi-Media Assets (not shown) available at step 401 for Consumers 221, 222 to electronically purchase, lease, or register. A Retail Operator 202, connected to the communication medium noted as IP Network 211, at step 402 presents an online customer portal application via IP Network 211 for Consumers 221, 222 to electronically purchase, lease, or register these Multi-Media Assets at step 403. The Retail Operator 201, in response to the Consumer 221 purchasing one or more selected Multi-Media Assets at step 404, electronically ships a purchased, leased, or registered Multi-Media Asset at step 405 to a Network-Based Consumer Multi-Media Library 205 that is designated by the Consumer 221. A Network-Based Consumer Multi-Media Library 205 is provided by a Storage Operator 204 that typically implements multiple Network-Based Consumer Multi-Media Libraries for the storage of Multi-Media Assets for the associated Consumers 221, 222. Multi-Media Assets stored in a Network-Based Consumer Multi-Media Library 205 are accessible to a Multi-Media on Demand (MMoD) Operator 207. A Multi-Media on Demand Operator 207 at step 406 presents a user interface for a Consumer 221 to select a Multi-Media Asset. This is accomplished at step 407 when the Consumer 221 accesses the user interface presented by the Multi-Media on Demand Operator 207 to select one of the Multi-Media Assets owned by or accessible to the Consumer 221 for playback on demand. A Multi-Media on Demand Operator 207, in response to the Consumer selection, launches the selected Multi-Media Asset for playback to the Consumer 221 at step 408 in response to the Consumer 221 selecting a particular Multi-Media Asset. A Consumer 221 that purchased a Multi-Media Asset on physical media such as a DVD may alternatively register that purchase with a Retail Operator 202 to obtain an online copy of the Multi-Media Asset in a Network-Based Consumer Multi-Media Library 205, just as if the Consumer 221 had purchased the Multi-Media Asset online.

### Content Owner

A Content Owner 201 may collaborate with a Retail Operator 202 to electronically sell, lease, or register its Multi-Media Assets to online Consumers 221, 222. A Content Owner 201 may authorize the Retail Operator 202 to store these Multi-Media Assets in its online merchandise inventory; may specify the Consumer terms and conditions of each sale, lease, or registration; and may specify terms and conditions for other electronic retail value chain elements that may interact with the Retail Operator 202, including Storage Operators 204 or Multi-Media on Demand Operators 207. A Content Owner 201 may furnish the Retail Operator 202 with at least one copy of each Multi-Media Asset to be electronically sold, leased, or registered, including any variants encoded in different formats, e.g., standard definition (SD), high definition (HD), etc. A Content Owner 201 may also define the Multi-Media Asset Entitlement format for each Multi-Media Asset that Consumers 221, 222 may register electronically. In the Video-on-Demand Asset Mass Storage System 200, a Content Owner 201 may also specify rules governing content ubiquity for purchased, leased, or registered Multi-Media Asset including Publisher/Subscriber sharing or re-publication restrictions, allowable devices for viewing, and other rules or terms related to Multi-Media Asset usage in the Video-on-Demand Asset Mass Storage System 200.

### Retail Operator

A Retail Operator 202 is an e-commerce business that operates one or more online retail outlets, e.g., Internet web sites. A Retail Operator 202 may own and operate every element of its operations, or it may subcontract any of these elements, e.g., customer account management or online payment services. For example, Amazon.com may function as a Retail Operator 202 and may subcontract PayPal.com to receive online payments.

A Retail Operator 202 may receive a Multi-Media Asset inventory from each Content Owner 201 that it conducts business with, or from other sources. The Retail Operator 202 stores this Multi-Media Asset inventory on any suitable digital mass storage media. A Storage Operator 204 and/or 206 may host the storage for this inventory in a Retail Operator Library. The Retail Operator 202 must store at least one copy of each Multi-Media Asset inventoried for sale or lease, including any required variants of each Multi-Media Asset such as standard definition (SD) or high definition (HD) formats, etc.

A Retail Operator 202 provides an online customer interface for Consumers 221, 222 to browse or search the Multi-Media Asset inventory and to purchase, lease, or register Multi-Media Assets. For leased Multi-Media Assets, the Retail Operator 202 may assign the lease terms, including the lease duration, and may give the Consumers 221, 222 the option to adjust the lease terms or duration.

The order fulfillment process requires the Consumers 221, 222 to designate an Electronic Shipping Address for each Multi-Media Asset purchased, leased, or registered. An Electronic Shipping Address denotes a Network-Based Consumer Multi-Media Library 205 held by a Storage Operator 204 for Consumer 221, which Library could be shared in whole or in part with Consumer 222 (such as family members having individual libraries with the parents having universal access.) An Electronic Shipping Address may comprise a username, password, E-mail address, Storage Operator 204 identity, account number, name of a Network-Based Consumer Multi-Media Library 205, or any other information. The order fulfillment process may interact with the designated Storage Operator 204 via the Retail API for each Multi-Media Asset listed on the Bill of Sale to validate the Electronic Shipping Address for each Multi-Media Asset.

A Network-Based Consumer Multi-Media Library 205 must have sufficient unused capacity to store any purchased, leased, or registered Multi-Media Asset or Multi-Media Asset Entitlement that is electronically shipped to it. The order fulfillment process may interact with the Storage Operator 204 via the Retail API to verify sufficient storage capacity exists prior to completing the sale. The order fulfillment process may advise the Consumers 221, 222 when a Multi-Media Asset or Multi-Media Asset Entitlement is undeliverable due to insufficient storage capacity in the Network-Based Consumer Multi-Media Library 205, and it may remove undeliverable items from the Bill of Sale before completing the sale; or it may warn the Consumers 221, 222 that insufficient space exists and ship the Multi-Media Asset or Multi-Media Asset Entitlement to the Storage Operator 204 to be held for delivery until the Consumers 221, 222 have provisioned sufficient storage space in the Network-Based Consumer Multi-Media Library 205, whereupon the Storage Operator 204 releases the hold and delivers the Multi-Media Asset or Multi-Media Asset Entitlement to the Network-Based Consumer Multi-Media Library 205. The order fulfillment process may send the finalized Bill of Sale to the Consumers 221, 222 at any time before, during, or after the electronic shipping process has concluded.

For each Multi-Media Asset electronically purchased, leased, or registered, the Retail Operator 202 electronically ships the Multi-Media Asset or an associated Multi-Media Asset Entitlement to the designated Storage Operator 204. Electronic shipping methods may include the Internet, HTTP, FTP, local or remote file copy operation, customized Multi-Media Asset delivery software, or any other computerized delivery methods. Multi-Media Assets shipped electronically are shipped from the Retail Operator's Multi-Media Asset inventory or from some other source. Electronic shipments may occur immediately or on a scheduled basis. Multi-Media Asset lease terms, which may include ownership and right-to-use terms, are electronically shipped with each leased Multi-Media Asset. In the Video-on-Demand Asset Mass Storage System 200, Multi-Media Asset lease terms may also specify rules governing content ubiquity for a leased Multi-Media Asset including Publisher/Subscriber sharing or re-publication restrictions, allowable devices for viewing, and other rules or terms governing leased Multi-Media Asset usage in the Video-on-Demand Asset Mass Storage System 200.

The electronic shipping process may interact with the Storage Operator 204 via the Retail API to determine whether to ship a Multi-Media Asset versus a Multi-Media Asset Entitlement. If the Storage Operator 204 already holds a suitable copy of the Multi-Media Asset, shipping a Multi-Media Asset Entitlement instead of the Multi-Media Asset will avoid burdening the Storage Operator 204 with multiple identical copies of the same Multi-Media Asset. The Retail Operator 202 composes a Multi-Media Asset Entitlement in the format specified by the Content Owner 201 or in a format accepted by the Storage Operator 204.

In the special case where the Retail Operator 202 and the Storage Operator 204 are the same entity, e.g., a cable operator, the electronic shipping process may be simplified considerably and may, for example, consist of the cable operator using a simple file copy operation to create a copy of the purchased, leased, or registered Multi-Media Asset or a Multi-Media Asset Entitlement in the designated Network-Based Consumer Multi-Media Library 205, along with the Multi-Media Asset lease terms, if applicable.

### Consumer

Consumers 221, 222 electronically purchase, lease or register a Multi-Media Asset via a Retail Operator 202 and specify an Electronic Shipping Address for that Multi-Media Asset. The Retail Operator 202 ships the purchased, leased or registered Multi-Media Asset to a designated Network-Based Consumer Multi-Media Library 205 at the specified Electronic Shipping Address; the Network-Based Consumer Multi-Media Library 205 is provided by a Storage Operator 204. Consumers 221, 222 may have accounts registered with multiple Storage Operators 204, 206. Consumers 221, 222 may use an online Consumer Storage Interface to perform Storage Operator account management functions. Consumers 221, 222 may use a Consumer Multi-Media on Demand Interface provided by a Multi-Media on Demand Operator 207 to select a Multi-Media Asset from a Network-Based Consumer Multi-Media Library 205 for playback on demand. The Multi-Media on Demand Operator 207 may access the Network-Based Consumer Multi-Media Library 205 and stream the Multi-Media Asset to Consumers 221, 222 for viewing. Consumers 221, 222 may view a leased Multi-Media Asset on demand during the leasing period in accordance with the lease terms.

A Content Owner 201 or other source may retail its Multi-Media Assets to Consumers 221, 222 on physical media, e.g., in DVD format, and may include with each physical Multi-Media Asset sold a license certificate or other conveyance containing a key value that uniquely identifies the particular Multi-Media Asset copy, e.g., a Multi-Media Asset title combined with a manufacturer's serial number, or a Multi-Media Asset Identifier, or any other suitable key value format. Keys may be encoded or encrypted to thwart forgeries. Consumers 221, 222 may register this key online to have an electronic version of the Multi-Media Asset deposited in a designated Network-Based Consumer Multi-Media Library 205, just as if Consumers 221, 222 had electronically purchased the Multi-Media Asset online.

While many different Multi-Media Asset registration processes are possible, the preferred process is as follows. Consumers 221, 222 locate a Retail Operator 202 that can register the Multi-Media Asset; such a Retail Operator 202 holds the corresponding Multi-Media Asset in its Multi-Media Asset inventory or can temporarily access or acquire a copy of the requested Multi-Media Asset to complete the registration process. Consumers 221, 222 use the Retail Operator 202 online customer interface to access the Multi-Media Asset registration process. Consumers 221, 222 supply the Multi-Media Asset key, an Electronic Shipping Address, and any other information requested by the Retail Operator 202. The Retail Operator 202 collaborates with an authoritative source via a Key Registration API to definitively validate the key and universally verify the key is eligible for registration; details are beyond the scope of the present Video-on-Demand Asset Mass Storage System 200. The authoritative source may be the Content Owner 201 of this Multi-Media Asset, an entity authorized by the Content Owner 201, or some other source. If the key is eligible for registration, the authoritative source may permanently or universally register the key in the Consumer's name and grants the Retail Operator 202 permission to electronically ship the Multi-Media Asset to the Electronic Shipping Address provided by Consumers 221, 222; otherwise, the registration request is rejected. After the key is registered, the Retail Operator 202 may complete the Multi-Media Asset registration process by invoking the order fulfillment and electronic shipping processes just as if Consumers 221, 222 had electronically purchased the Multi-Media Asset online.

In the Video-on-Demand Asset Mass Storage System 200, Consumers 221, 222 may have additional capabilities including Publisher/Subscriber capabilities for multi-media content ubiquity, whereby Consumers 221, 222 may grant or receive access to view Multi-Media Assets held by other Consumers 221, 222.

### Storage Operator

A Storage Operator 204 provides long-term Multi-Media Asset Storage for Multi-Media Assets electronically purchased, leased, or registered by Consumers 221, 222. A Storage Operator 204 provides an account and one or more Network-Based Consumer Multi-Media Libraries 205 to each of Consumers 221, 222 that it hosts. A Storage Operator 204 may assign a quota limiting the storage capacity of each Network-Based Consumer Multi-Media Library 205 or limiting the total storage capacity of all Consumer Libraries held by Consumers 221, 222. A Storage Operator 204 may bill Consumers 221, 222 periodically for storage allocation or storage utilization.

A Storage Operator 204 may provide an online Consumer Storage Interface for Consumers 221, 222 to perform account management, e.g., update billing information; increase or decrease storage quotas; define policies for managing Network-Based Consumer Multi-Media Library content or mass storage allocation when the current storage utilization reaches a quota, e.g., delete or archive the least recently used Multi-Media Assets or the oldest Multi-Media Assets; automatically purchase additional space incrementally; and other account management functions as required. The presentation and functionality of the Consumer Storage Interface is beyond the scope of the present Video-on-Demand Asset Mass Storage System 200 and need not be identical for all Storage Operators 204.

A Storage Operator 204 holds Consumer Multi-Media Assets in a logical container called a Network-Based Consumer Multi-Media Library 205. This construct may take many different forms and is described here in purely illustrative terms. Quite generally, a Network-Based Consumer Multi-Media Library 205 comprises a Multi-Media Asset Catalog 205A and a persistent Multi-Media Asset Storage Facility 205B. The Multi-Media Asset Catalog 205A is an index system comprising Multi-Media Asset Catalog Entries and supporting Multi-Media Asset storage and retrieval by name. The Multi-Media Asset Storage Facility 205B holds the digital Multi-Media Asset files deposited in the Network-Based Consumer Multi-Media Library 205.

A Network-Based Consumer Multi-Media Library 205 may be stored in a file system, database, custom software application, or any other suitable facility. Each Multi-Media Asset Catalog 205A Multi-Media Asset Catalog Entry in a Network-Based Consumer Multi-Media Library 205 describes a Multi-Media Asset held in the Multi-Media Asset Storage Facility 205B of that Network-Based Consumer Multi-Media Library 205 and provides a means to access that Multi-Media Asset, for example, to perform playback on demand. Consumers 221, 222 may inspect and manage Multi-Media Assets stored in the Network-Based Consumer Multi-Media Library 205 via the Consumer Storage Interface. A Storage Operator 204 may hold or access Multi-Media Assets in one or more Storage Operator Libraries, and a Storage Operator 204 may store the Multi-Media Asset inventory for a Retail Operator 202 in a Retail Operator Library. The Storage Operator Library construct and the Retail Operator Library construct may be identical to the Network-Based Consumer Multi-Media Library construct.

A Storage Operator 204 may provide server-side support for two different network APIs. The Retail API supports the Retail Operator 204 order fulfillment and electronic shipping processes; and the Multi-Media on Demand API supports the Multi-Media on Demand Operator 2070n-Demand Multi-Media Asset Delivery process. A suitable high-speed network architecture and network infrastructure interconnects Consumers 221, 222, Retail Operators 202, Storage Operators 204, and Multi-Media on Demand Operators 207 and may incorporate the public Internet, semi private or private networks, or a combination of these or any other network types. Network and API standards and protocols are determined by requirements and may support secure or encrypted network communications.

Storage Operator support for the Retail API may include capabilities to validate a Consumer 221, 222 storage account; verify sufficient unused Network-Based Consumer Multi-Media Library 205 storage capacity to receive an electronically-shipped Multi-Media Asset; determine whether a Multi-Media Asset Entitlement may be shipped instead of a Multi-Media Asset; receive a Multi-Media Asset or Multi-Media Asset Entitlement shipment; catalog a newly received Multi-Media Asset in a designated Network-Based Consumer Multi-Media Library 205; electronically deposit a Multi-Media Asset file in the Multi-Media Asset Storage Facility 205B of a designated Network-Based Consumer Multi-Media Library 205; and other capabilities consistent with the order fulfillment and electronic shipping processes.

A Storage Operator 204 may support multiple Multi-Media Asset Entitlement formats. Upon receiving a Multi-Media Asset Entitlement from a Retail Operator 202, a Storage Operator 204 may store a copy of the associated Multi-Media Asset in the designated Network-Based Consumer Multi-Media Library 205. The source for this copy may be an identical Multi-Media Asset held in another Network-Based Consumer Multi-Media Library 205, a Storage Operator Library, or a Retail Operator Library. Alternatively, to avoid mass storage proliferation, the Storage Operator 204 may initialize the Multi-Media Asset Catalog 205A Multi-Media Asset Catalog Entry for a Multi-Media Asset Entitlement as a synonym, e.g., a pointer, link, or alias, for an identical Multi-Media Asset copy held in another Network-Based Consumer Multi-Media Library 205, a Storage Operator Library, or a Retail Operator Library. A synonym construct consumes only a trivial amount of storage space compared to a Multi-Media Asset file. Further, a Storage Operator 204 may implement storage optimization techniques to improve mass storage efficiencies. The Storage Operator 204 may delete each leased Multi-Media Asset from its associated Network-Based Consumer Multi-Media Library 205 immediately upon lease expiration.

Storage Operator 204 support for the Multi-Media on Demand API may include capabilities to authenticate a Multi-Media on Demand Operator 207; validate a Multi-Media on Demand Operator 207 request; access a designated Network-Based Consumer Multi-Media Library 205; list the contents of a Network-Based Consumer Multi-Media Library 205; obtain Multi-Media Asset properties or characteristics; read a Multi-Media Asset file over the network 211; launch a playback stream for a specified Multi-Media Asset; process Multi-Media Asset playback trick modes; transfer a Multi-Media Asset copy to a Multi-Media on Demand Operator 207; and other capabilities consistent with the On-Demand Multi-Media Asset Delivery process. In the Video-on-Demand Asset Mass Storage System 200, a Storage Operator 204 may implement the Publisher/Subscriber content ubiquity model for sharing Multi-Media Assets among Consumers 221, 222 and the Electronic Content Asset Gateway for Multi-Media on Demand Operators 207.

### Multi-Media on Demand Operator

A Multi-Media on Demand Operator 207 may implement one or more Consumer Multi-Media on Demand Interfaces for Consumers 221, 222 to playback Multi-Media Assets on demand. This interface may be an on-screen interactive program guide (IPG) provided by a set-top box or equivalent television receiver; an online user interface, e.g., a web-based interface; or any other suitable interface. Interface presentation and navigation details are beyond the scope of the present Video-on-Demand Asset Mass Storage System 200 and need not be identical for all Multi-Media on Demand Operators 207. In the Video-on-Demand Asset Mass Storage System 200, a Consumer Multi-Media on Demand Interface may be implemented as GUI-IPG, GUI-WEB, or GUI-WED.

The Consumer Multi-Media on Demand Interface allows Consumers 221, 222 to identify their Storage Operators 204, 206 and Network-Based Consumer Multi-Media Libraries 205, e.g., by selecting from a list of popular Storage Operators 204, 206, or by inputting Storage Operator account information from a virtual or physical keyboard, or by other means. Consumers 221, 222 with multiple Storage Operator accounts may define each account via this interface. Similarly, Consumers 221, 222 may identify any or all Network-Based Consumer Multi-Media Libraries 205 associated with each Storage Operator account.

A Multi-Media on Demand Operator 207 may store Storage Operator account information and Network-Based Consumer Multi-Media Library 205 account information provided by each Consumer 221, 222 in a persistent Consumer Profile. A Multi-Media on Demand Operator 207 may use a Consumer Profile to locate and display the Multi-Media Assets the Consumers 221, 222 may playback on demand, e.g., by issuing Multi-Media on Demand API calls to each Storage Operator 204 listed in the Consumer Profile to obtain the Multi-Media Asset titles held in the Network-Based Consumer Multi-Media Libraries 205 listed in the Consumer Profile. Consumers 221, 222 may use a Consumer Multi-Media on Demand Interface to browse these Multi-Media Assets and select a Multi-Media Asset for playback on demand.

When Consumers 221, 222 select a Multi-Media Asset for playback, the Multi-Media on Demand Operator 207 may interact with the associated Storage Operator 204 to execute the On-Demand Multi-Media Asset Delivery process. This process may invoke the Multi-Media on Demand API to perform one or more functions between the Multi-Media on Demand Operator 207 and the Storage Operator 204 such as user authentication; Multi-Media Asset verification or validation, e.g. to verify compatible Multi-Media Asset recording format or encoding; download a Multi-Media Asset for playback; open a Multi-Media Asset file for reading over the network; launch a Multi-Media Asset playback stream; etc. Ultimately, the Multi-Media on Demand Operator 207 will use its multi-media on demand transmission methods and facilities, which may be proprietary, to stream the requested Multi-Media Asset for Consumer viewing. A Multi-Media on Demand Operator 207 may enhance its On-Demand Multi-Media Asset Delivery process by implementing Video-on-Demand Asset Mass Storage System 200 content ubiquity techniques including the Publisher/Subscriber model and the Electronic Content Asset Gateway.

### Multi-Media Asset Storage

From the above description, including the above-listed parent patent applications, it is evident that it is not unlikely that multiple copies of a Multi-Media Asset may be extant on each of the various Storage Operator 204 facilities, since the plurality of Consumers 221, 222 who implement Network-Based Consumer Multi-Media Libraries 205 on these systems likely have many Multi-Media Assets in common. This redundancy of storage usage on a particular Storage Operator 204 is then compounded across the multitude of Storage Operators 206 as well as their associated Network-Based Consumer Multi-Media Libraries 205. Therefore, a selected Multi-Media Asset can be replicated numerous times, making the utilization of the storage space inefficient.

In describing the management of this redundancy, a Distinct Asset is defined as any digital multi-media file stored in a Video on Demand Library that resides on mass storage, such as a Network-Based Consumer Multi-Media Library 205 which is accessible to the video on demand transmission systems of Multi-Media on Demand Operator 207. Consumers 221, 222 may acquire Distinct Assets through direct purchase, from file sharing services, by uploading or importing content, by recording program content as it airs, e.g., movies, series episodes, ballgames, or by any other means. Consumers 221, 222 may use a Distinct Asset recording facility provided by an operator that may be a Network Video Recorder, Network Video Content Recorder, or any other suitable streaming media application. Similarly, an operator may create or acquire a Distinct Asset using the same methods that Consumers 221, 222 may use.

An Alias is a synonym for a Distinct Asset or for some other physical copy of a Distinct Asset. The Alias construct may be implemented as a Multi-Media Asset File Location, which may be represented in any convenient form such as a Uniform Resource Locator (URL), a Unix file system hard link or symbolic link, a block device name and a list of the block storage locations comprising a Distinct Asset file, a pointer or other synonym to a Multi-Media Asset Catalog 205A Multi-Media Asset Catalog Entry in another Network-Based Consumer Multi-Media Library 205, or any other form. Zero or more Aliases exist for every Distinct Asset. The binary relation “is an Alias of” is a transitive relation. A Direct Alias is an Alias that directly references a Distinct Asset, e.g., one for which a single application of a Multi-Media Asset Catalog 205A query operation for a given Alias returns a Distinct Asset. A Transitive Alias is an Alias that directly references another Alias, e.g., one for which a single application of a Multi-Media Asset Catalog 205A query operation for a given Alias returns an Alias. Ultimately, each Transitive Alias must transitively de-reference a Distinct Asset. One or more Aliases or one or more acyclic Transitive Alias chains from one or more Video on Demand Library instances may alias a Distinct Asset or some other Alias. An Alias in a Network-Based Consumer Multi-Media Library 205 may reference a Distinct Asset or an Alias in the same Network-Based Consumer Multi-Media Library 205 or in another Network-Based Consumer Multi-Media Library 205, or in an Operator Library. An Alias in an Operator Library may reference a Distinct Asset or an Alias in the same Operator Library or in another Operator Library or in a Network-Based Consumer Multi-Media Library 205.

Alias Name Resolution is the process of transitively enumerating a given Alias to locate the associated Distinct Asset. For example, this process may consist in iterative applications of a Multi-Media Asset Catalog 205A query operation, where each iteration queries the Alias returned from the previous iteration until the query returns a Multi-Media Asset Catalog 205A Multi-Media Asset Catalog Entry for a Distinct Asset. The implementation may use caching or other strategies to reduce subsequent Distinct Asset access times. The implementation may, for example, use Alias Name Resolution to locate a requested Distinct Asset to launch its playback on demand.

Asset Multiplicity M≧0 is a measure of the number of contemporaneous Aliases for a Distinct Asset or Alias such that M=0 if and only if no Aliases exist for that Distinct Asset or Alias. Asset Multiplicity M>0 means at least one Alias exists for that Distinct Asset or Alias. The Asset Multiplicity measure may be defined in many different ways. For example, M>0 may mean M Direct Aliases exist for a Distinct Asset, or it may mean M Transitive Aliases exist for a given Direct Asset or Alias, or it may mean a grand total of M Aliases exist for a Distinct Asset or Alias. The implementation shall provide the capability to determine the current Asset Multiplicity M of each Distinct Asset including identical Distinct Asset copies, and may provide the capability to determine the current Asset Multiplicity M of each Alias. The implementation shall properly maintain Asset Multiplicity measures as the system operates over time, i.e., as the system and its Consumers 221, 222 or the operator create and delete Multi-Media Assets or reorganize Video on Demand Library inventories.

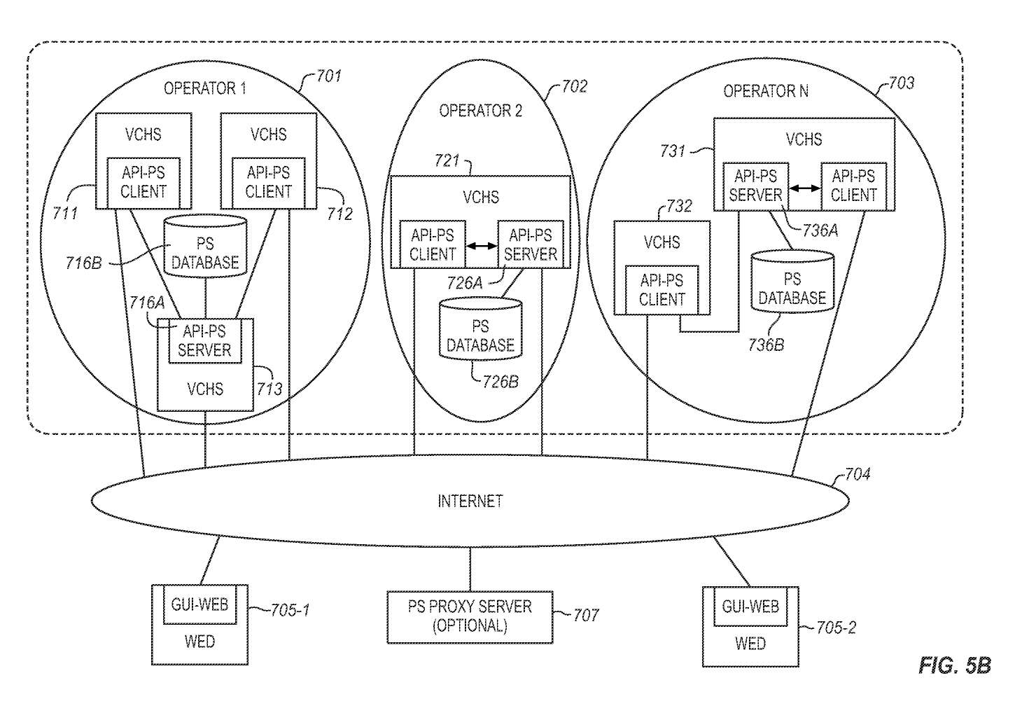

As shown in FIG. 6, the preferred implementation uses Reference Counts to represent and determine Asset Multiplicity. A Reference Count is a software primitive commonly used to indicate the existence of logical copies of an item. This count is denoted by an integer N≧0 such that N=0 if and only if no logical copies exist. A Reference Count N>0 indicates N Aliases exist for that Distinct Asset or Alias per the Asset Multiplicity implementation. For example, N>0 may mean that N Direct Aliases exist for a Distinct Asset, or that a total of N Aliases exist for a Distinct Asset or Alias. The implementation shall properly maintain these Reference Counts to satisfy Asset Multiplicity tests or inquiries on Distinct Assets and Aliases. For example, the Distinct Asset creation process shall initialize the associated Reference Count N to zero; the Alias creation process shall increase the appropriate Reference Count(s) Nᵢ by one; and the Alias deletion process shall decrease the appropriate Reference Count(s) Nᵢ by one. At least one Asset Multiplicity measure M exists that is equivalent to a canonical Reference Count implementation where the Reference Count N for each Distinct Asset or Alias records the current number of synonyms for that Distinct Asset or Alias.

A Video on Demand Library (equivalently, a Network-Based Consumer Multi-Media Library 205) can be defined in terms of a mathematical structure G=(V, E) called a Directed Acyclic Graph (DAG), where V is the set of vertices and E is the set of edges in G. The vertex set V contains interior vertices and leaf vertices. Every interior vertex of G has an out-degree of one. Every leaf vertex of G has an out-degree of zero. Every interior vertex of G is an Alias, and every leaf vertex of G is a Distinct Asset or an identical Distinct Asset copy. Each edge in G is directed from one vertex in G to another vertex in G and is labeled with the Multi-Media Asset File Location that relates its associated vertices. The implementation may create any number of Directed Acyclic Graphs to represent the Video on Demand Library contents. A single Directed Acyclic Graph may span multiple Video on Demand Library instances.

The implementation may incorporate various Multi-Media Asset management strategies, any of which may be controlled or influenced by operator-specified policies or parameters. For example, the Asset Creation Strategy determines whether to create a Multi-Media Asset as a Distinct Asset or as an Alias; the Alias Association Strategy determines which particular Distinct Asset an Alias shall reference among multiple identical Distinct Asset copies.

To facilitate management of identical Distinct Asset copies, a Multi-Media Asset Identifier (Asset ID) may be associated to a Distinct Asset. A Multi-Media Asset Identifier unambiguously identifies a Distinct Asset and provides a means to detect or manage identical Distinct Asset copies stored within one or more contemporaneous Video on Demand Libraries. While there are many implementation possibilities, ideally a Multi-Media Asset Identifier is assigned from a universal namespace managed by an authoritative source (e.g., Content Owner, film studio, standards body, e-retailer, Multi-Media on Demand Operator 207 upon asset ingest) so as to guarantee uniqueness; cf. the assignment of a worldwide unique MAC address to each Ethernet card ever produced, regardless of the manufacturer. An authoritative source could, for example, assign a worldwide unique Multi-Media Asset Identifier to the movie “My Cousin Vinny”. Any machine-readable copy of that particular movie could include that unique Multi-Media Asset Identifier in a media descriptor encoded as part of that copy. Application software can compare Multi-Media Asset Identifiers from two or more Distinct Assets or Distinct Asset copies to test for strict equivalence among these Distinct Assets. Other forms of Multi-Media Asset Identifier include, but are not limited to, computed values such as strong checksums calculated from the Multi-Media Asset digital content. It might be possible to determine or assign the Multi-Media Asset Identifier before the Multi-Media Asset is created, initiated, or finalized, using information provided by a Consumer, operator or Content Owner; or using the Multi-Media Asset title information or Multi-Media Asset source information; or using other known or given Multi-Media Asset attributes. For example, when a Consumer 221 uses a Network Video Recorder to record a television series episode for which the Content Owner has already assigned an Asset ID, the recording process may create the Multi-Media Asset Catalog Entry for this recording and assign this Asset ID as the Multi-Media Asset Identifier shortly before recording begins.

The Multi-Media Asset creation process may be implemented as follows. First, the implementation invokes the Asset Creation Strategy to determine whether to create a Distinct Asset or an Alias. To create an Alias, the Alias Association Strategy selects the target Alias, Distinct Asset, or identical Distinct Asset copy that the new Alias will reference. The Asset Placement Strategy selects a Video on Demand Library instance for the new Alias. Within the selected Video on Demand Library instance, the implementation creates and initializes a Multi-Media Asset Catalog 205A Multi-Media Asset Catalog Entry of type “Alias” that binds the new Alias to the target Alias, Distinct Asset, or identical Distinct Asset copy, e.g., via the Multi-Media Asset File Location. The Multi-Media Asset Multiplicity of the new Alias is set to zero, and the associated Multi-Media Asset Logical Delete Indicator is set to “NOT DELETED”. The Multi-Media Asset Identifier is assigned if known; otherwise, the Multi-Media Asset Identifier is set to “UNKNOWN” and is determined and assigned at a later time. The Multi-Media Asset Owner field of the Multi-Media Asset Catalog Entry may be initialized with the Consumer's unambiguous identity at this time.

Similarly, to create a Distinct Asset, the Asset Placement Strategy selects a Video on Demand Library instance for the Multi-Media Asset Catalog 205A Multi-Media Asset Catalog Entry and selects a Video on Demand Library instance for the Distinct Asset multi-media file. The Asset Placement Strategy may select the same Video on Demand Library in both cases, or it may select two different Video on Demand Libraries. For a Spanned Library configuration, the selected Video on Demand Library instances may both be Consumer Libraries, Operator Libraries, or one of each depending on the implementation. The implementation stores the Distinct Asset multi-media file in the Video on Demand Library selected for this multi-media file. The implementation creates and initializes a Multi-Media Asset Catalog Entry of type “Distinct Asset” within the Video on Demand Library selected for this Multi-Media Asset Catalog Entry and binds the Multi-Media Asset Catalog Entry to the Distinct Asset multi-media file, e.g., via the Multi-Media Asset File Location. The Multi-Media Asset Multiplicity of the new Distinct Asset is set to zero, and the associated Multi-Media Asset Logical Delete Indicator is set to “NOT DELETED”. The Multi-Media Asset Identifier is assigned if known; otherwise, the Multi-Media Asset Identifier is set to “UNKNOWN” and is determined and assigned at a later time. The Multi-Media Asset Owner field of the Multi-Media Asset Catalog Entry may be initialized with the Consumer's unambiguous identity at this time.

When N>1 Consumers simultaneously record the same Multi-Media Asset on operator mass storage, e.g., the same episode of a television series, the recording process may use the Asset Creation Strategy and the Asset Duplication Strategy to determine the number K of identical Distinct Asset copies to create, 0≦K≦N, where N−K recordings may be represented as Aliases, and the Asset Placement Strategy invoked by the recording process may individually assign each identical Distinct Asset copy to a Video on Demand Library. Similarly, when a Consumer creates or initiates a Multi-Media Asset by any means, the Asset Creation Strategy invoked by the Multi-Media Asset creation process may attempt to locate a Distinct Asset that is identical to the one that would be created or initiated or has already been created or initiated, for example, by searching one or more Video on Demand Libraries for a Distinct Asset that has an identical Asset ID. If an identical Distinct Asset is found, the Asset Creation Strategy may choose to represent the new Multi-Media Asset as an Alias of the identical Distinct Asset. In these examples, and in any case where a Multi-Media Asset is created, initiated, or finalized, the implementation may create an Alias to avoid allocating mass storage.

A Consumer, operator, or policy-driven implementation may delete a Multi-Media Asset. The deletion request is processed immediately or is deferred depending on the implementation and possibly on factors such as Asset Multiplicity. Immediate Deletion removes the Multi-Media Asset from the Video on Demand Library when the Immediate Deletion request is processed. Deferred Deletion marks the Multi-Media Asset as logically deleted, but the Multi-Media Asset remains within the Video on Demand Library and remains fully accessible by others upon conclusion of Deferred Deletion request processing.

An Alias deletion request may be processed immediately or may be deferred depending on the implementation. For example, Immediate Deletion of an Alias A may consist in assigning A's Multi-Media Asset File Location, α, to the Multi-Media Asset File Location of each Direct Alias of A, and deleting A's Multi-Media Asset Catalog Entry. By contrast, if A's Asset Multiplicity M>0, Deferred Deletion may consist in setting A's Multi-Media Asset Logical Delete Indicator to “DELETED” and deferring A's Multi-Media Asset Catalog Entry deletion until A's Asset Multiplicity M=0, a condition that may be inspected periodically, e.g., automatically on a timed basis, or event driven. Other Alias deletion strategies are also possible.

Similarly, a deletion request for a Distinct Asset or an identical Distinct Asset copy may be deferred based on Asset Multiplicity considerations. For example, when a Distinct Asset D is deleted, if D's Asset Multiplicity M>0, Deferred Deletion may consist in setting D's Multi-Media Asset Logical Delete Indicator to “DELETED” and deferring deletion of D's Distinct Asset file and Multi-Media Asset Catalog Entry until D's Asset Multiplicity M=0. As another example, if A is an identical Distinct Asset copy of D, deletion of D may consist in assigning Δ's Multi-Media Asset File Location, δ, to the Multi-Media Asset File Location of each Direct Alias of D, and then deleting D's Distinct Asset file and Multi-Media Asset Catalog Entry. Other Distinct Asset deletion strategies are possible.

The implementation may perform Multi-Media Asset de-duplication, maintenance, optimization, or garbage collection functions such as discovering and deleting unnecessary identical Distinct Asset copies (for example, by searching one or more contemporaneous Video on Demand Libraries for a Distinct Asset that has an identical Asset ID); creating identical Distinct Asset copies as required; deleting Aliases, Distinct Assets, or identical Distinct Asset copies with Asset Multiplicity M=0; collapsing, eliminating, or reorganizing Transitive Alias chains; removing redundant Aliases; correcting anomalous relations, e.g., deleting an Alias that references a non existent Multi-Media Asset; defragmenting, reorganizing, compressing, or compacting Video on Demand Libraries, etc. These functions may be initiated by the operator or performed by the implementation, e.g., automatically on a timed basis, or event driven, or in accordance with system management policies or rules.

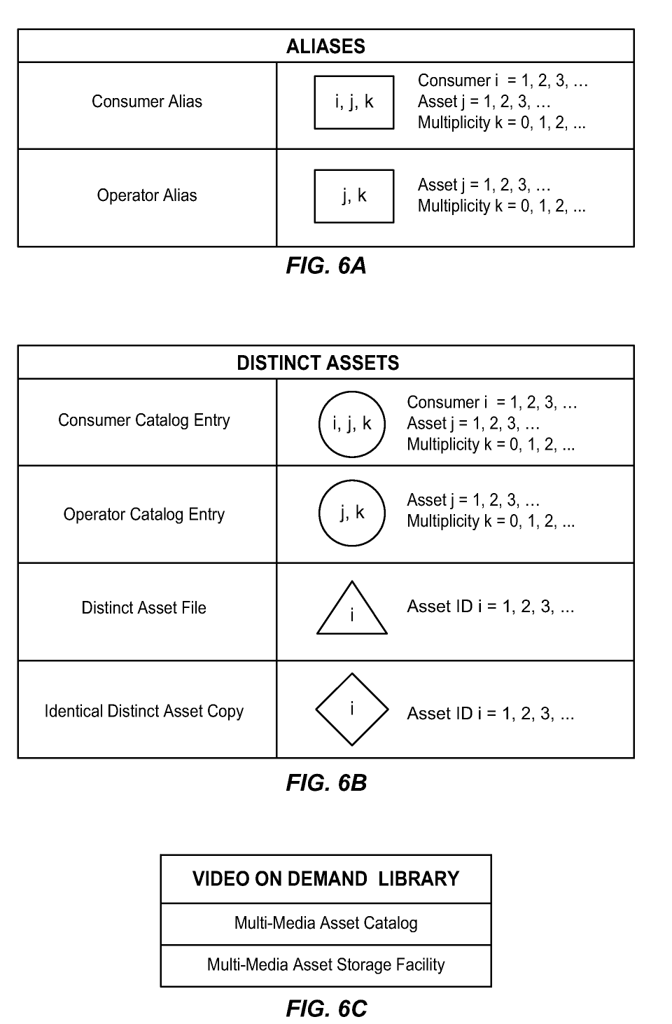

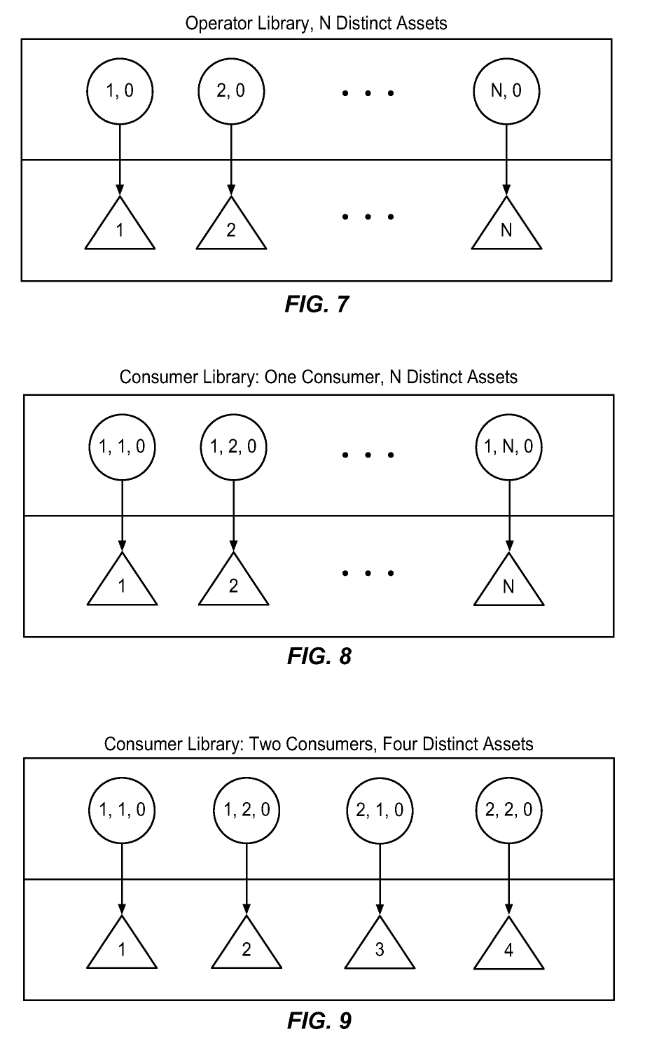

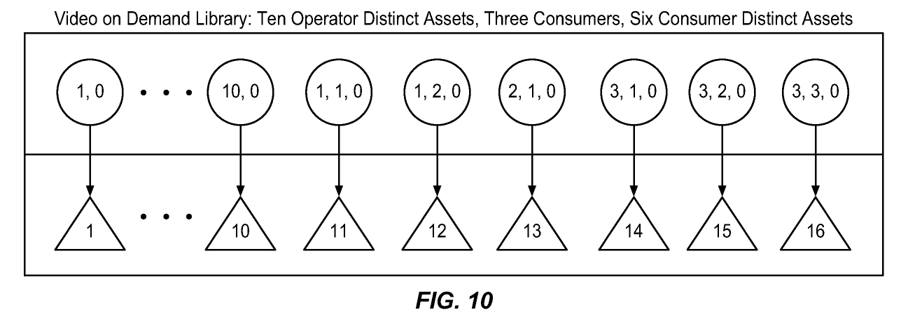

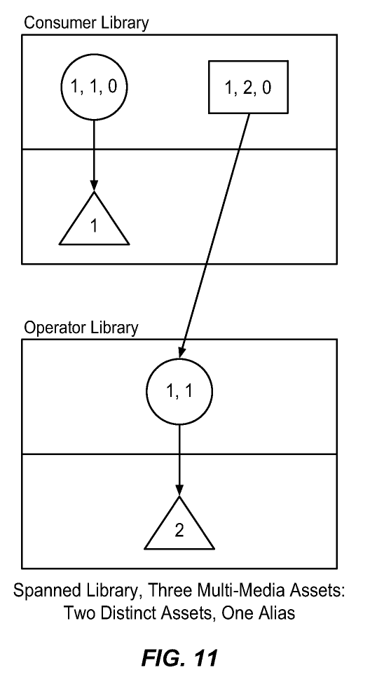

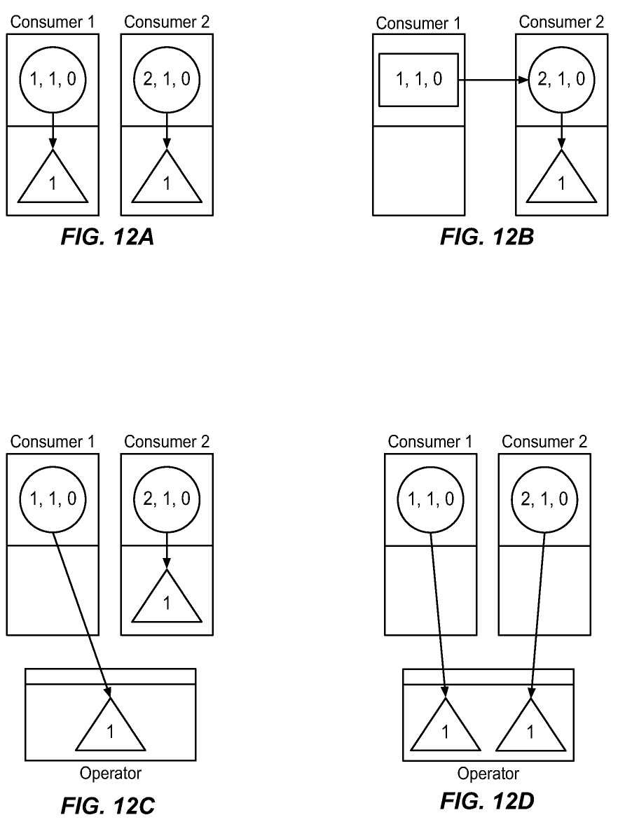

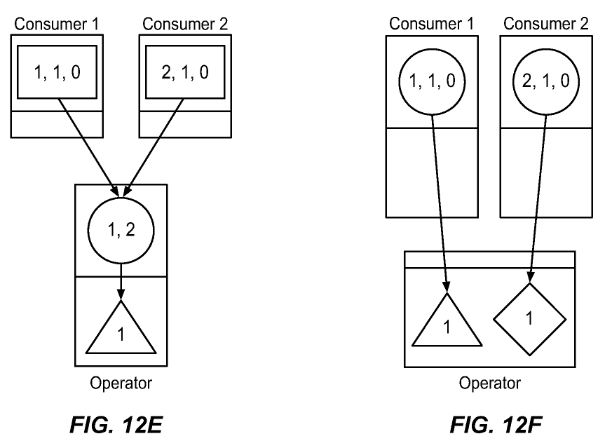

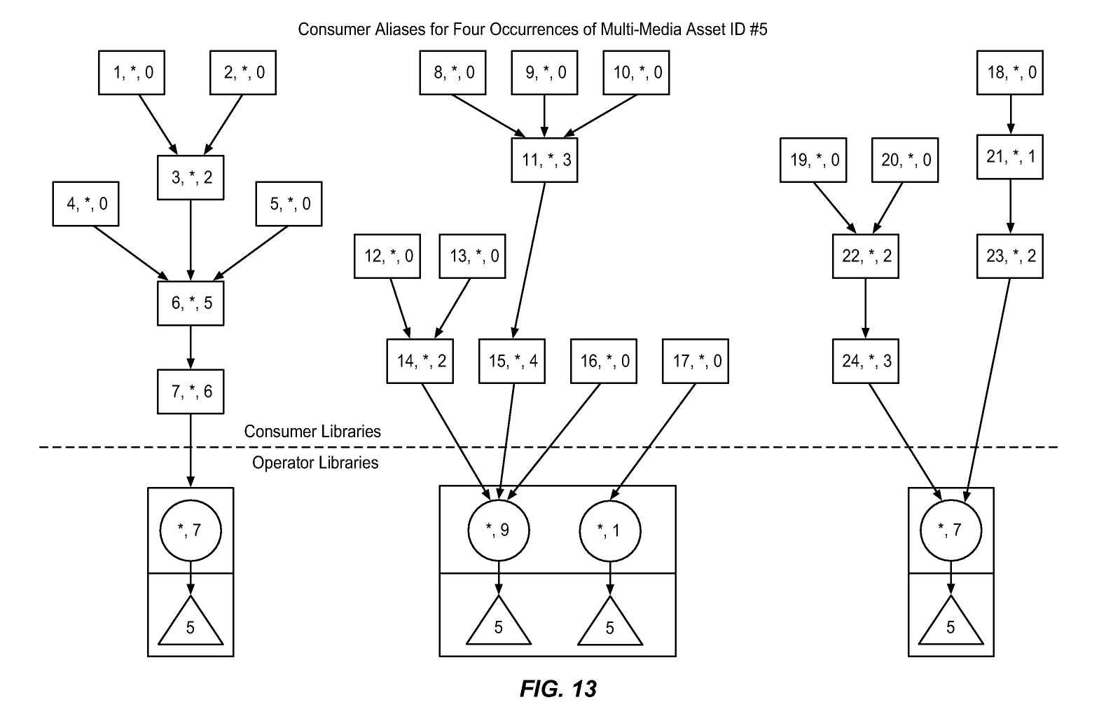

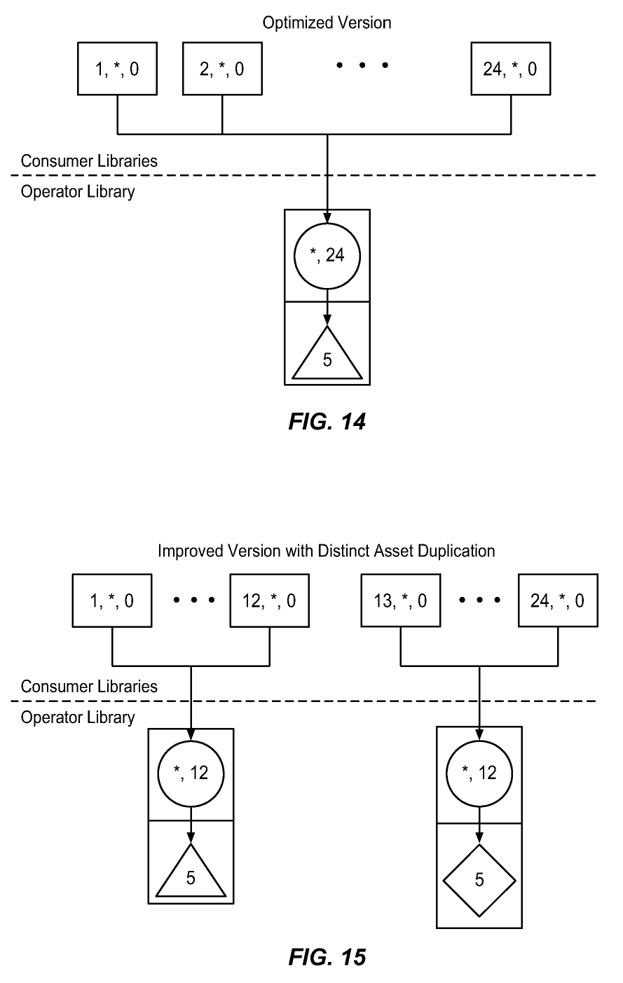

FIG. 6 depicts the nomenclature used in FIGS. 7 through 15. The Asset Multiplicity measure for each Multi-Media Asset shown in FIGS. 7 through 15 is defined as the total number of Aliases currently defined for that Multi-Media Asset; other Asset Multiplicity measures are possible. FIG. 7 depicts an Operator Library with N Distinct Assets. FIG. 8 shows a Consumer Library holding N Distinct Assets for one Consumer. FIG. 9 portrays a Consumer Library holding two Distinct Assets for each of two Consumers. FIG. 10 illustrates a Video on Demand Library holding ten operator Distinct Assets, two Distinct Assets for a first Consumer, one Distinct Asset for a second Consumer, and three Distinct Assets for a third Consumer. FIG. 11 depicts a Spanned Library comprising a Consumer Library and an Operator Library. The Consumer Library holds one Distinct Asset and an Alias for a Distinct Asset held in the Operator Library. FIGS. 12a-12f show six different representations of two Consumers holding a Multi-Media Asset with an Asset ID of “1”. FIGS. 12a, 12c, and 12d each depict two occurrences of the same Distinct Asset as might be the case before de-duplication is performed, whereas FIG. 12f represents one Multi-Media Asset as an identical Distinct Asset copy of the other Multi-Media Asset, as might be the case after de-duplication has been performed. FIGS. 14 and 15 illustrate how the implementation may dynamically improve the representation of FIG. 13 using the methods described in the present Video-on-Demand Asset Mass Storage System. Each of the 24 Aliases shown in FIG. 13 belongs to a different Consumer, and each Alias is stored in a Consumer Library belonging to its owner (Consumer Libraries are omitted for clarity.) These 24 Consumers are divided into four groups where each group aliases a Distinct Asset with an Asset ID of “5”; three Operator Libraries store four occurrences of this Distinct Asset. FIG. 14 shows the simplest equivalent representation of FIG. 3 wherein the implementation has detected and eliminated multiple occurrences of the District Asset to conserve mass storage, and Alias chains are replaced with Direct Aliases to improve Direct Asset access times. FIG. 15 shows an equivalent representation of FIG. 13 wherein the Consumers are divided into two groups: one group aliases a Distinct Asset, the other group aliases an identical copy of that Distinct Asset, and Alias chains are replaced with Direct Aliases.

### SUMMARY

The Video-on-Demand Asset Mass Storage System uses Asset Multiplicity and Asset ID information to replace redundant Multi-Media Asset copies with space-efficient pointers to a smaller number of physical Multi-Media Asset copies.

What is claimed as new and desired to be protected by Letters Patent of the United States is:

1. A Video-on-Demand Asset Mass Storage System, operable in a communication network, for providing multi-media assets on demand to selected consumers, comprising:
at least one network-based consumer multi-media library means for storing a consumer's multi-media assets and multi-media asset aliases, each multi-media asset alias comprising a digital certificate that uniquely identifies said consumer and an associated multi-media asset for access by said consumer; and
multi-media asset storage management means, responsive to the presence of a plurality of copies of the same multi-media asset in said at least one network-based consumer multi-media library means, for converting at least one of said same multi-media asset into an associated multi-media asset alias for storage in said at least one network-based consumer multi-media library means.

2. The Video-on-Demand Asset Mass Storage System of claim 1 wherein said multi-media asset storage management means comprises:
duplication detection means, responsive to a consumer requesting storage of a selected multi-media asset in said at least one network-based consumer multi-media library means, for determining the presence of a plurality of copies of said selected multi-media asset in said at least one network-based consumer multi-media library means.

3. The Video-on-Demand Asset Mass Storage System of claim 2 wherein each of said multi-media assets is assigned a Multi-Media Asset Identifier which unambiguously identifies each of said multi-media assets, said duplication detection means comprises:
multi-media asset name detection means for using said Multi-Media Asset Identifier to determine the presence of a plurality of copies of said selected multi-media asset in said at least one network-based consumer multi-media library means.

4. The Video-on-Demand Asset Mass Storage System of claim 1 wherein said multi-media asset storage management means comprises:
multi-media asset storage locator means for assigning a storage locator to each multi-media asset and multi-media asset alias stored in said at least one network-based consumer multi-media library means, wherein an associated multi-media asset alias points to the storage locator of a multi-media asset or another multi-media asset alias in said at least one network-based consumer multi-media library means.

5. The Video-on-Demand Asset Mass Storage System of claim 4 wherein said multi-media asset storage management means further comprises:
multi-media asset name resolution means for transitively enumerating a multi-media asset from a given multi-media asset alias of said multi-media asset.

6. The Video-on-Demand Asset Mass Storage System of claim 5 wherein said multi-media asset storage management means further comprises:
multi-media asset multiplicity measurement means for determining a number of multi-media asset copies from said associated multi-media asset aliases.

7. The Video-on-Demand Asset Mass Storage System of claim 5 wherein said multi-media asset storage management means further comprises:
multi-media asset alias reordering means, responsive to said multi-media asset name resolution means, for converting a multi-media asset alias that points to another multi-media asset alias to point to the associated multi-media asset.

8. A method of operating a Video-on-Demand Asset Mass Storage System, operable in a communication network, for providing multi-media assets on demand to selected consumers, comprising:
storing in at least one network-based consumer multi-media library a consumer's multi-media assets and multi-media asset aliases, each multi-media asset alias comprising a digital certificate that uniquely identifies said consumer and an associated multi-media asset for access by said consumer; and
converting, in response to the presence of a plurality of copies of the same multi-media asset in said at least one network-based consumer multi-media library, at least one of said same multi-media asset into an associated multi-media asset alias for storage in said at least one network-based consumer multi-media library.

9. The method of operating a Video-on-Demand Asset Mass Storage System of claim 8 wherein said step of converting comprises:
determining, in response to a consumer requesting storage of a selected multi-media asset in said at least one network-based consumer multi-media library, the presence of a plurality of copies of said selected multi-media asset in said at least one network-based consumer multi-media library.

10. The method of operating a Video-on-Demand Asset Mass Storage System of claim 9 wherein each of said multi-media assets is assigned a Multi-Media Asset Identifier which unambiguously identifies each of said multi-media assets, said step of determining comprises:
identifying multi-media asset names using said Multi-Media Asset Identifier to determine the presence of a plurality of copies of said selected multi-media asset in said at least one network-based consumer multi-media library.

11. The method of operating a Video-on-Demand Asset Mass Storage System of claim 8 wherein said step of converting comprises:
assigning a storage locator to each multi-media asset and multi-media asset alias stored in said at least one network-based consumer multi-media library, wherein an associated multi-media asset alias points to the storage locator of a multi-media asset or another multi-media asset alias in said at least one network-based consumer multi-media library.

12. The method of operating a Video-on-Demand Asset Mass Storage System of claim 11 wherein said step of converting further comprises:
transitively enumerating a multi-media asset from a given multi-media asset alias of said multi-media asset.

13. The method of operating a Video-on-Demand Asset Mass Storage System of claim 12 wherein said step of converting further comprises:
determining a number of multi-media asset copies from said associated multi-media asset aliases.

14. The method of operating a Video-on-Demand Asset Mass Storage System of claim 12 wherein said step of converting further comprises:
converting, in response to said multi-media asset name resolution means, a multi-media asset alias that points to another multi-media asset alias to point to the associated multi-media asset.
